(19) United States
(12) Patent Application Publication
(10) Pub. No.: US 2025/0339916 A1
(43) Pub. Date: Nov. 6, 2025

(54) METHOD FOR POWER SUPPLY IN RESISTANCE WELDING

(71) Applicant: Clifford Group FZCO, Dubai (AE)

(72) Inventors: Iain Ambler, Pietermaritzburg (ZA); Scott Liebenberg, Loves Park, IL (US)

(73) Assignee: Clifford Group FZCO, Dubai (AE)

(21) Appl. No.: 19/270,051

(22) Filed: Jul. 15, 2025

Related U.S. Application Data
(63) Continuation of application No. 18/626,927, filed on Apr. 4, 2024.

(51) Int. Cl. B23K 11/24

(52) U.S. Cl. CPC B23K 11/241

(57) ABSTRACT

Components of an electrical resistance welding system include a DC power supply, an energy storage assembly, a switch, and an electrical resistance welding assembly configured to weld a work piece. The system may be free of any transformer which permits the system to operate in an infinite number of variable voltages between a minimum and maximum system setting. The variable voltage control permits greater operability of the electrical resistance welding system by creating a specific weld voltage dependent on parameter, such as a dimension, of the work piece that is to be welded.

### CROSS REFERENCE TO RELATED APPLICATIONS

The present disclosure is a continuation application of U.S. patent application Ser. No. 18/626,927, filed on Apr. 4, 2024, the entirety of which is incorporated herein by reference.

### TECHNICAL FIELD

This disclosure is directed to an electrical resistance welding system.

### BACKGROUND ART

Electrical resistance welding has been widely used for over 100 years, for machines such as spot welders, mesh welders, grating welders, jig welders, car assembly plants, amongst many others etc. Electrical resistance welding has been used to weld sheet metal products, wire products, flat bar and many other profiles and shapes. Some of the more common materials used are low carbon steels, but it is also possible with certain alloy steels, stainless steels, and even nonferrous metals like Aluminum and Copper.

Traditional electrical resistance welding systems include alternating current (AC) Welding, direct current (DC) Welding, Three Phase DC Welding, MFDC Welding (Medium Frequency Direct Current), and capacitive discharge (CD) welding.

Alternating Current (AC) welding is a process that uses an electric arc to create heat to melt and join metals. An AC power supply creates an electric arc between a consumable or non-consumable electrode and the base material using alternating currents. In AC welding machines, the transformer is used to convert the high-voltage input from the wall plug (usually from 208 to 600 volts) into a low alternating current (AC) (usually from 15 to 55 amps). This current may be further transformed to a lower voltage of up to 80 volts and a range of welding currents up to 1000 amps AC or more, depending on the process and equipment.

Direct Current (DC) welding uses a direct current to supply electricity to an electrode that joins the two metals being welded together. Unlike AC, the DC current flows in one direction only and has no crossovers, which would cool the part, resulting in the part heating more quickly.

Three Phase DC Welding can be configured in three different configurations: Closed Delta, Wye, or Open Delta. Welding current output by three phase DC welding systems may continue on an uninterrupted basis. In three-phase DC welding machines, three-phase AC is fed to rectifier units which, in turn, feed DC to a single output circuit. The output in a welding rectifier is always direct current (DC). This can be either constant or variable DC.

MFDC Welding is a control and power supply system that takes an AC power input and converts it into an inverted, higher frequency power output. In MFDC welding machines, three-phase AC, for example 60 hertz, input is converted to a high frequency, for example 400-4000 Hz. It may be powered by a transistor inverter, supplying usually square wave, for example 500 V at 1000 Hz, which is converted by the MF transformer to a low alternating voltage at high current. This low voltage current can be rectified to DC by a diode block built into the transformer and is then used for welding.

CD welding uses capacitors to quickly discharge electrical energy through a threaded or unthreaded weld stud. The electrical energy liquefies the pip of the stud. Simultaneously, spring pressure in the hand tool forces the stud down into the molten pool, forming a weld that is stronger than the parent material. In CD welding machines, electrical power is stored in a capacitor and discharged through a transformer into the workpieces. Most production CD welding systems in use today employ air core style transformers for matching capacitor output to the workpiece load.

Some of the above systems, such as AC welding, has welding transformers, because resistance welding depends on high welding current at low voltage. The high current is required to obtain sufficient power applied to the welding. Namely, Power=I²*R. The low welding voltage is required to make the welding process controllable and to reduce arcing/sparking/blow out, to ensure good quality, and repeatable welds. The low secondary voltage also makes the process safe for the machine operator.

The transformer is an enormous inductor. As such, there are significant inductor losses inside the transformer. Further, a cooling fluid, such as water, must be pumped through the transformer which results in wasted energy. Additionally, the transformer only works with alternating current. However, the most ideal way to weld is with direct current. Because of the use of alternating current. The current must be rectified via rectifier diodes. The rectifier diodes are another inefficiency in the transformer-based welding process.

When using a 480 V main power supply, the welding transformer turns ratio will typically be approximately 50:1. This reduces the secondary welding voltage to below 0v and means that the secondary welding current will be up to 50 times higher than the primary current.

To provide sufficient welding power these welding transformers are high kvA power transformers. The typical range is approximately from 20 kvA to 4000 kvA. The inductive losses in these high kvA welding transformers are very significant. Often, they will operate in the region of about 50% power factor, so the real power (usable for welding) can be as low as 50% of the apparent.

It can be understood from the foregoing that there are clear disadvantages of using transformers in resistance welding systems that typically require high welding current at low voltage. AC transformers struggle to efficiently deliver the high welding currents required for resistance welding, which can lead to overheating and inconsistent welds. The constantly changing voltage in AC welding can pose challenges in maintaining precise control over the low-voltage settings needed for resistance welding. When using DC welding, High power rectifier diodes are required, which have a resistance volt drop across them which causes heating and more energy loss. The diodes must be cooled (along with the transformer), and they have finite life at these high currents. They require careful maintenance and care and are widely acknowledged as a weak point in resistance welding systems. In Three Phase DC Welding, managing high currents at low voltage can be intricate, potentially leading to inconsistencies in the welding process. The substantial current requirements in three-phase DC systems can make the equipment less portable and challenging to use in applications requiring mobility. In MFDC welding, achieving precise control over high current at low voltage, a necessity in resistance welding, can be complex due to the use of high-frequency inverters and intricate electronics. Maintaining the equipment's performance and reliability in MFDC welding setups with high currents at low voltage levels may require specialized expertise and frequent maintenance. Capacitive discharge welding relies on intense bursts of high current at low voltage, which can strain components that are not optimized for short welding cycles.

### SUMMARY OF THE INVENTION

Having thus recognized that the usage of transformers in electrical resistance welding is inefficient, the present disclosure seeks to improve electrical resistance welding technology. Namely, aspects of the present disclosure teach welding techniques and technology that avoid the high inductive losses in the transformer itself, and the resistive losses in the DC rectifier diodes. Thus, aspect of the present disclosure detail embodiments for electrical resistance welding that do not use (i.e., are free from) transformers and/or DC rectifier diodes.

In one exemplary aspect, one embodiment of the present disclosure provides a multi-spot welding system that uses a bank of supercapacitors and a MOSFET or another transistor-based weld switch. The current supplied by the capacitor bank is genuine DC (for the short duration of the weld). As such, no diode rectification or PWM control of the welding current is required. This exemplary embodiment or another exemplary provides a weld control system that exploits the fact that the supercapacitor bank can be charged to any voltage between 0 and 9v. Thus, the ideal voltage can be selected that is required for the plate thickness (or wire diameter) being welded. This provides an ideal technique of weld setting that eliminates the need for an in efficient heat percentage setting. For resistance welding, this is ideal as it enables welding to occur at any voltage specifically for the workpiece or product being welded. This is an improvement over previous limitations of transformers as they are limited to one voltage as determined by the transformer turns ratio. As such, the system of the present disclosure simplifies the welding process by only requiring the system to set the capacitor charge voltage and a welding time.

In one exemplary embodiment of the present disclosure, the current switching occurs downstream of the capacitor or energy storage assembly. Thus, the full welding current must be switched. The semiconductor-based solutions proved to be the best options to implement this current switching. Some exemplary switching solutions include a GTO Thyristor switch, an IGBT thyristor switch, and a MOSFET based welding switch. A simple direct contact switch using a pneumatic cylinder is also possible.

In this example, it has been determined that one exemplary semiconductor weld switching system was the MOSFET-based switch. This exemplary embodiment has up to sixteen parallel N-channel MOSFET's, mounted in two banks of eight transistor, with one central source busbar and two drain busbars. The MOSFET-based switch can switch a continuous current of 600 A, with a resistance of only 1.3 milliohm. In one example, the switching time is less than 0.3 milliseconds. The timing and control of the gate switching for the MOSFETS is completed with a microprocessor, such as a PLC using digital outputs or other semiconductor for the MOSFET gate switching. The PLC can use RS485 communications to pass the required capacitor voltage to the DC power supply. In one embodiment, a standard analog PLC input is used to supply the actual capacitor voltage to the PLC, so that the PLC is able to determine when the next weld can be initiated. The next weld can be triggered by the PLC as soon as or in response to when the capacitor voltage has recovered after the previous weld. Typically, this needs to be within 0.5 s for a mesh welder and about 1.5 sec for a jig welder. Because the welding voltage can be varied there is usually no need for traditional slope settings. However, if slope is required at the beginning of a weld this can easily be achieved by using PWM switching of the MOSFET switch at the start of the weld, at the beginning of each weld.

In yet another aspect, an exemplary embodiment of the present disclosure may provide a welding system comprising: a direct current (DC) power supply; an energy storage assembly comprising at least one supercapacitor; a switch that switches current from the energy storage device between an off-state and an on-state; and an electrical resistance welding assembly. This exemplary embodiment or another exemplary may further provide that the DC power supply is operatively located upstream from the energy storage assembly, the switch, and the electrical resistance welding assembly. This exemplary embodiment or another exemplary may further provide that the energy storage assembly is operatively located downstream from the DC power supply, and the energy storage assembly is operatively located upstream from the switch and the electrical resistance welding assembly. This exemplary embodiment or another exemplary may further provide that the switch is operatively located downstream from the energy storage device as it receives electrical current from the energy storage device, and the switch is operatively located upstream from the electrical resistance welding assembly. This exemplary embodiment or another exemplary may further provide that the electrical resistance welding assembly is located operatively downstream from the switch inasmuch as it receives current from the switch in order to perform an electrical resistance weld on a metal component that is to be joined or welded together. This exemplary embodiment or another exemplary may further include a selected voltage range of the energy storage assembly, wherein the voltage range is from 0 volts (V) to about 12 V, wherein the at least one supercapacitor is selectively charged to any voltage within the voltage range. This exemplary embodiment or another exemplary may further include current supplied by the DC power supply, the current having a plurality of selectable voltages, wherein the voltages of the current are selectively chosen based on a parameter of a work piece to be welded by the electrical resistance welding assembly. This exemplary embodiment or another exemplary may further provide that the switch comprises at least one semiconductor. This exemplary embodiment or another exemplary may further provide that the at least one semiconductor is a MOSFET transistor. This exemplary embodiment or another exemplary may further provide that the energy storage assembly further comprises: a plurality of supercapacitors; and a first group of at least two supercapacitors arranged electrically in series with each other. This exemplary embodiment or another exemplary may further provide that the first group includes at least three supercapacitors arranged electrically in series with each other. This exemplary embodiment or another exemplary may further provide that the energy storage assembly further comprises: a second group of at least two supercapacitors arranged electrically in series with each other. This exemplary embodiment or another exemplary may further provide that the first group is arranged electrically in parallel to the second group.

In another aspect, another exemplary embodiment of the present disclosure may provide a method comprising: transferring direct current from a positive terminal on a direct current (DC) power supply; receiving direct current from the DC power supply at a first positive terminal on an energy storage device; transferring direct current from a second positive terminal on the energy storage device; receiving direct current from the second positive terminal on the energy storage assembly at a first terminal on a switch; transitioning the switch between an off state and an on state; transferring direct current from a second terminal on the switch; receiving direct current from the second terminal on the switch at a positive terminal on an electrical resistance welding assembly; welding a work piece with direct current in the electrical resistance welding assembly; transferring direct current from a negative terminal on the electrical resistance welding assembly; receiving direct current from the negative terminal on the electrical resistance welding assembly at a first negative terminal on the energy storage assembly; transferring direct current from a second negative terminal on the energy storage assembly; and receiving direct current from the second negative terminal on the energy storage assembly at a negative terminal on the DC power supply. This exemplary embodiment or another exemplary may further include adjusting a variable voltage output from the DC power supply, wherein voltage is adjustably varied between 0 volts (V) and 12 V. This exemplary embodiment or another exemplary may further include determining a dimension of the work piece to be welded; and adjusting the variable voltage of the direct current to a value corresponding to the dimension of the work piece. This exemplary embodiment or another exemplary may further include maintaining a steady direct current output from the positive terminal on the DC power supply regardless of voltage fluctuations due to changes in resistance during welding of the work piece in the electrical resistance welding assembly which is adapted to maintain consistency of welding in the electrical resistance welding assembly. This exemplary embodiment or another exemplary may further include continuously transferring direct current from the positive terminal on the DC power supply as the switch transitions repeatedly between an on-state and an off-state. This exemplary embodiment or another exemplary may further include continuously transferring direct current from the positive terminal on the DC power supply to the energy storage assembly as voltage in the energy storage assembly drops in response to the work piece being welded in the electrical resistance weld assembly. This exemplary embodiment or another exemplary may further include transferring direct current from the positive terminal on the DC power supply to at least one supercapacitor in the energy storage assembly. This exemplary embodiment or another exemplary may further include charging a first group of a plurality of supercapacitors of the energy storage assembly, wherein the plurality of supercapacitors in the first group are electrically in series with each other. This exemplary embodiment or another exemplary may further include charging a second group of a plurality of supercapacitors of the energy storage assembly, wherein the plurality of supercapacitors in the second group are electrically in series with each other, wherein the first group is electrically parallel to the first group. This exemplary embodiment or another exemplary may further include setting an output voltage of the energy storage assembly, wherein the output voltage is determined by the number of supercapacitors that are in series with each other. This exemplary embodiment or another exemplary may further include charging at least one supercapacitor to a voltage that that is dependent on a maximum thickness of the work piece that is to be welded in the electrical resistance welding assembly. This exemplary embodiment or another exemplary may further include receiving a user-selected or PLC-selected output voltage of the energy storage assembly that is dependent on a thickness of the work piece that is to be welded in the electrical resistance welding assembly. This exemplary embodiment or another exemplary may further include receiving, continuously, the direct current at the first positive terminal of the energy storage assembly regardless of voltage fluctuations due to changes in resistance during welding of the work piece in the electrical resistance welding assembly. This exemplary embodiment or another exemplary may further include charging, continuously, a supercapacitor on the energy storage assembly as the switch transitions repeatedly between an on-state and an off-state. This exemplary embodiment or another exemplary may further provide that charging the supercapacitor and discharging direct current from the supercapacitor occur simultaneously. This exemplary embodiment or another exemplary may further provide that the DC power supply, the energy storage assembly, the switch, and the electrical resistance welding assembly are free of any transformer. This exemplary embodiment or another exemplary may further provide that transitioning the switch from the off state to the on state is accomplished by a semiconductor. This exemplary embodiment or another exemplary may further include provide that the semiconductor is a Metal-Oxide-Semiconductor Field-Effect Transistor (MOSFET). This exemplary embodiment or another exemplary may further include transferring direct current through a first bank of a first plurality of semiconductors on the switch; and transferring direct current through a second bank of a second plurality of semiconductors on the switch, wherein the first bank of the first plurality of semiconductors is electrically parallel to the second bank of the of the second plurality of semiconductors. This exemplary embodiment or another exemplary may further include transferring direct current through a source busbar, wherein a source connection on each of the semiconductors in the first bank and the second bank are electrically connected to the source busbar. This exemplary embodiment or another exemplary may further include transferring direct current through a drain busbar, wherein the drain busbar has at least two portions, wherein direct current is transferred from a drain connection on each of the semiconductors in the first bank to a first portion of the drain busbar and direct current is transferred from a drain connection on each of the semiconductors in the second bank to a second portion of the drain busbar. This exemplary embodiment or another exemplary may further include transferring direct current from the first portion of the drain busbar and the second portion of the drain busbar to a central portion of the drain busbar, wherein the second terminal is connected to the central portion of the drain busbar. This exemplary embodiment or another exemplary may further include transferring, simultaneously, a gate voltage to each gate connection of the first plurality of semiconductors and the second plurality of semiconductors, wherein the gate voltage is controlled by a programmable logic controller (PLC). This exemplary embodiment or another exemplary may further include transitioning the switch from the off state to the on state in less than about 0.3 milliseconds.

In yet another aspect, an exemplary embodiment of the present disclosure may provide a computer program product including one or more non-transitory machine-readable mediums encoded with instructions that when executed by one or more processors cause a process to be carried out for welding a work piece in an electrical resistance welding assembly that receives direct current from a direct current (DC) power supply via an energy storage assembly and a switch, wherein the instructions comprise: instructions to transfer direct current from a positive terminal on the DC power supply; instructions to receive direct current from the DC power supply at a first positive terminal on the energy storage device; instructions to transfer direct current from a second positive terminal on the energy storage device; instructions to receive direct current from the second positive terminal on the energy storage assembly at a first terminal on the switch; instructions to transition the switch between an off state and an on state; instructions to transfer direct current from a second terminal on the switch; instructions to receive direct current from the second terminal on the switch at a positive terminal on an electrical resistance welding assembly; instructions to welding a work piece with direct current in the electrical resistance welding assembly; instructions to transferring direct current from a negative terminal on the electrical resistance welding assembly; instructions to receive direct current from the negative terminal on the electrical resistance welding assembly at a first negative terminal on the energy storage assembly; instructions to transfer direct current from a second negative terminal on the energy storage assembly; and instructions to receiving direct current from the second negative terminal on the energy storage assembly at a negative terminal on the DC power supply. This exemplary embodiment or another exemplary may further include instructions to adjust a variable voltage output from the DC power supply, wherein voltage is adjustably varied between 0 volts (V) and 12 V. This exemplary embodiment or another exemplary may further include instructions to determining a dimension of the work piece to be welded; and instructions to adjusting the variable voltage of the direct current to a value corresponding to the dimension of the work piece. This exemplary embodiment or another exemplary may further include instructions to maintain a steady direct current output from the positive terminal on the DC power supply regardless of voltage fluctuations due to changes in resistance during welding of the work piece in the electrical resistance welding assembly which is adapted to maintain consistency of welding in the electrical resistance welding assembly. This exemplary embodiment or another exemplary may further include instructions to continuously transfer direct current from the positive terminal on the DC power supply as the switch transitions repeatedly between an on-state and an off-state. This exemplary embodiment or another exemplary may further include instructions to continuously transfer direct current from the positive terminal on the DC power supply to the energy storage assembly as voltage in the energy storage assembly drops in response to the work piece being welded in the electrical resistance weld assembly. This exemplary embodiment or another exemplary may further include instructions to transfer direct current from the positive terminal on the DC power supply to at least one supercapacitor in the energy storage assembly. This exemplary embodiment or another exemplary may further include instructions to charge a first group of a plurality of supercapacitors of the energy storage assembly, wherein the plurality of supercapacitors in the first group are electrically in series with each other. This exemplary embodiment or another exemplary may further include instructions to charge a second group of a plurality of supercapacitors of the energy storage assembly, wherein the plurality of supercapacitors in the second group are electrically in series with each other, wherein the first group is electrically parallel to the first group. This exemplary embodiment or another exemplary may further include instructions to set an output voltage of the energy storage assembly, wherein the output voltage is determined by the number of supercapacitors that are in series with each other. This exemplary embodiment or another exemplary may further include instructions to charge at least one supercapacitor to a voltage that that is dependent on a maximum thickness of the work piece that is to be welded in the electrical resistance welding assembly. This exemplary embodiment or another exemplary may further include instructions to receive a user-selected or PLC-selected output voltage of the energy storage assembly that is dependent on a thickness of the work piece that is to be welded in the electrical resistance welding assembly. This exemplary embodiment or another exemplary may further include instructions to receive, continuously, the direct current at the first positive terminal of the energy storage assembly regardless of voltage fluctuations due to changes in resistance during welding of the work piece in the electrical resistance welding assembly. This exemplary embodiment or another exemplary may further include instructions to charge, continuously, a supercapacitor on the energy storage assembly as the switch transitions repeatedly between an on-state and an off-state. This exemplary embodiment or another exemplary may further provide that charging the supercapacitor and discharging direct current from the supercapacitor occur simultaneously. This exemplary embodiment or another exemplary may further provide that the DC power supply, the energy storage assembly, the switch, and the electrical resistance welding assembly are free of any transformer. This exemplary embodiment or another exemplary may further provide that transitioning the switch from the off state to the on state is accomplished by a semiconductor. This exemplary embodiment or another exemplary may further provide that the semiconductor is a Metal-Oxide-Semiconductor Field-Effect Transistor (MOSFET). This exemplary embodiment or another exemplary may further include instructions to transfer direct current through a first bank of a first plurality of semiconductors on the switch; and instructions to transfer direct current through a second bank of a second plurality of semiconductors on the switch, wherein the first bank of the first plurality of semiconductors is electrically parallel to the second bank of the of the second plurality of semiconductors. This exemplary embodiment or another exemplary may further include instructions to transfer direct current through a source busbar, wherein a source connection on each of the semiconductors in the first bank and the second bank are electrically connected to the source busbar. This exemplary embodiment or another exemplary may further include instructions to transfer direct current through a drain busbar, wherein the drain busbar has at least two portions, wherein direct current is transferred from a drain connection on each of the semiconductors in the first bank to a first portion of the drain busbar and direct current is transferred from a drain connection on each of the semiconductors in the second bank to a second portion of the drain busbar. This exemplary embodiment or another exemplary may further include instructions to transfer direct current from the first portion of the drain busbar and the second portion of the drain busbar to a central portion of the drain busbar, wherein the second terminal is connected to the central portion of the drain busbar. This exemplary embodiment or another exemplary may further include instructions to transfer, simultaneously, a gate voltage to each gate connection of the first plurality of semiconductors and the second plurality of semiconductors, wherein the gate voltage is controlled by a programmable logic controller (PLC). This exemplary embodiment or another exemplary may further include instructions to transition the switch from the off state to the on state in less than about 0.3 milliseconds.

In yet another aspect, another exemplary embodiment of the present disclosure may provide an energy storage assembly comprising: a first plate having a first negative terminal and a second negative terminal; a second plate having a first positive terminal and a second positive terminal; a plurality of supercapacitors coupled to the first plate and the second plate; a first group of at least two supercapacitors from the plurality of supercapacitors, wherein the first group are arranged electrically in series with each other; and a second group of at least two supercapacitors from the plurality of supercapacitors, wherein the second group are arranged electrically in series with each other; wherein the first group is arranged electrically in parallel to the second group. This exemplary embodiment or another exemplary may further provide that the energy storage assembly is a component of an electrical resistance welding system. This exemplary embodiment or another exemplary may further include a maximum output voltage of the energy storage assembly that is dependent on a maximum thickness of a work piece that is to be welded in an electrical resistance welding assembly that is electrically coupled to the energy storage assembly. This exemplary embodiment or another exemplary may further include a user-selected or PLC-selected output voltage of the energy storage assembly that is dependent on a thickness of a work piece that is to be welded in an electrical resistance welding assembly that is electrically coupled to the energy storage assembly. This exemplary embodiment or another exemplary may further include an output voltage of the energy storage assembly, wherein the output voltage is determined by the number of supercapacitors that are in series with each other. This exemplary embodiment or another exemplary may further provide that the first negative terminal is configured to be in electrical communication with a direct current (DC) power supply. This exemplary embodiment or another exemplary may further provide that the second negative terminal is configured to be in electrical communication with an electrical resistance welding assembly. This exemplary embodiment or another exemplary may further provide that the first positive terminal is configured to be in electrical communication with a DC power supply. This exemplary embodiment or another exemplary may further provide that the first positive terminal is configured to be in electrical communication with a switch. This exemplary embodiment or another exemplary may further provide that the plurality of supercapacitors includes twelve supercapacitors that arranged with a first group of three supercapacitors electrically in series, a second group of three supercapacitors electrically in series, a third group of three supercapacitors electrically in series, and a fourth group of three supercapacitors electrically in series. This exemplary embodiment or another exemplary may further provide that the four groups are electrically parallel with each other.

In yet another aspect, an exemplary embodiment of the present disclosure may provide a switch assembly for an electrical resistance welding system, the switch assembly comprising: a first terminal configured to be coupled with an energy storage assembly; a second terminal configured to be coupled with an electrical resistance welding assembly; at least one semiconductor that is in operative electrical communication with the first terminal and the second terminal to receive current from the energy storage assembly and selectively permit a transfer of current to the electrical resistance welding assembly in response to application of voltage to the at least one semiconductor to transition the switch assembly from an off-state to an on-state. This exemplary embodiment or another exemplary may further include a plurality of semiconductors that are in operative electrical communication with the first terminal and the second terminal to receive current from the energy storage assembly and selectively permit the transfer of current to the electrical resistance welding assembly in response to application of voltage simultaneously to each of the plurality of semiconductors to transition the switch assembly from the off-state to the on-state, wherein the at least one semiconductor is within the plurality of semiconductors. This exemplary embodiment or another exemplary may further include a first plurality of semiconductors defining a first bank of semiconductors; a second plurality of semiconductors defining a second bank of semiconductors; wherein the first bank of semiconductors is electrically parallel to the second bank for semiconductors. This exemplary embodiment or another exemplary may further provide that the first plurality of semiconductors are transistors, and the second plurality of semiconductors are transistors. This exemplary embodiment or another exemplary may further provide that the transistors are Metal-Oxide-Semiconductor Field-Effect Transistors (MOSFETs). This exemplary embodiment or another exemplary may further provide that the MOSFETs are N-channel MOSFETs. This exemplary embodiment or another exemplary may further include a source bus bar that is in electrical communication with the first terminal, wherein a source connection of each transistor is electrically connected to the source bus bar. This exemplary embodiment or another exemplary may further provide that the source busbar is formed by a central plate. This exemplary embodiment or another exemplary may further include a drain busbar that is in electrical communication with the second terminal, wherein the drain busbar is composed of a first drain busbar component and a second drain busbar component and a central drain busbar component that electrically connects the first drain busbar component with the second drain busbar component, wherein a drain connection of each transistor is electrically connected to the drain busbar. This exemplary embodiment or another exemplary may further provide that the drain busbar is formed by a U-shaped plate, wherein a first leg of the U-shaped plate defines the first drain busbar component, a second leg of the U-shaped plate defines the second drain busbar component, and a central leg of the U-shaped plate defines the central drain busbar component. This exemplary embodiment or another exemplary may further include a gate on each of the transistors, wherein the gate on each of the transistors is configured to receive a gate voltage signal from a Programmable Logic Controller (PLC) to switch the transistors between an off-state and an on-state. This exemplary embodiment or another exemplary may further include a U-shaped plate comprising a first leg, a second leg, and a central leg; a central plate located within a space between the first leg and the second leg of the U-shaped plate; a gap defined between a perimeter edge of the central plate and inner edges of the U-shaped plate, wherein the first bank of semiconductors and the second bank of semiconductors span the gap. This exemplary embodiment or another exemplary may further provide that the first bank of semiconductors and the second bank of semiconductors span the gap below the central plate and the U-shaped plate. This exemplary embodiment or another exemplary may further include a first support plate that supports the first bank of the semiconductors that span the gap below the central plate and the U-shaped plate. This exemplary embodiment or another exemplary may further include a second support plate that supports the second bank of the semiconductors that span the gap below the central plate and the U-shaped plate.

In yet another aspect, another exemplary embodiment of the present disclosure may provide a method comprising: confirming a direct current (DC) power supply is in operative electrical communication with an energy storage assembly, a switch, and an electrical resistance welding assembly that is adapted to weld a work piece; transferring direct current from a positive terminal on the DC power supply to the energy storage assembly, wherein the current is adapted to be transferred from the energy storage assembly through the switch to the electrical resistance welding assembly; and receiving direct current at a negative terminal on the DC power supply from the electrical resistance welding assembly in response to the work piece being welded. This exemplary embodiment or another exemplary may further include adjusting a variable voltage output from the DC power supply. This exemplary embodiment or another exemplary may further provide that the voltage is adjustably varied between 0 volts (V) and 12 V. This exemplary embodiment or another exemplary may further include determining a dimension of the work piece to be welded; and adjusting the variable voltage of the direct current to a value corresponding to the dimension of the work piece. This exemplary embodiment or another exemplary may further include setting the voltage output of from the DC power supply to a value that achieves a desired weld quality for the work piece. This exemplary embodiment or another exemplary may further include maintaining a steady direct current output from the positive terminal on the DC power supply regardless of voltage fluctuations due to changes in resistance during welding of the work piece in the electrical resistance welding assembly which is adapted to maintain consistency of welding in the electrical resistance welding assembly. This exemplary embodiment or another exemplary may further include causing the direct current transferred from the positive terminal on the DC power supply to charge a component of the energy storage assembly. This exemplary embodiment or another exemplary may further include continuously transferring direct current from the positive terminal on the DC power supply as the switch transitions repeatedly between an on-state and an off-state. This exemplary embodiment or another exemplary may further include continuously transferring direct current from the positive terminal on the DC power supply to the energy storage assembly as voltage in the energy storage assembly drops in response to the work piece being welded in the electrical resistance weld assembly. This exemplary embodiment or another exemplary may further include transferring direct current from the positive terminal on the DC power supply to at least one supercapacitor in the energy storage assembly. This exemplary embodiment or another exemplary may further include transferring direct current from the positive terminal on the DC power supply to a first group of a plurality of supercapacitors arranged electrically in series. This exemplary embodiment or another exemplary may further include transferring direct current from the positive terminal on the DC power supply to a second group of a plurality of supercapacitors arranged electrically in series, wherein the first group is electrically parallel to the second group.

In yet another aspect, an exemplary embodiment of the present disclosure may provide a method comprising: confirming that an energy storage assembly is in operative electrical communication with a direct current (DC) power supply, a switch, and an electrical resistance welding assembly that is adapted to weld a work piece; receiving direct current from the DC power supply at a first positive terminal on the energy storage assembly; charging at least one device of the energy storage assembly with the direct current; transferring direct current from a second positive terminal on the energy storage assembly to the switch, wherein the direct current is adapted to be transferred from the switch to the electrical welding assembly; receiving direct current at a first negative terminal on the energy storage assembly from the electrical resistance welding assembly in response to the work piece being welded; and transferring direct current from a second negative terminal on the energy storage assembly to the DC power supply. This exemplary embodiment or another exemplary may further provide that the at least one device is at least one supercapacitor. This exemplary embodiment or another exemplary may further include charging a first group of a plurality of supercapacitors of the energy storage assembly, wherein the plurality of supercapacitors in the first group are electrically in series with each other. This exemplary embodiment or another exemplary may further include charging a second group of a plurality of supercapacitors of the energy storage assembly, wherein the plurality of supercapacitors in the second group are electrically in series with each other. This exemplary embodiment or another exemplary may further provide that the first group is electrically parallel to the first group. This exemplary embodiment or another exemplary may further include setting an output voltage of the energy storage assembly, wherein the output voltage is determined by the number of supercapacitors that are in series with each other. This exemplary embodiment or another exemplary may further provide that there are at least three supercapacitors in the first group. This exemplary embodiment or another exemplary may further include charging the at least one supercapacitor to a voltage that that is dependent on a maximum thickness of the work piece that is to be welded in the electrical resistance welding assembly. This exemplary embodiment or another exemplary may further include receiving a user-selected or PLC-selected output voltage of the energy storage assembly that is dependent on a thickness of the work piece that is to be welded in the electrical resistance welding assembly. This exemplary embodiment or another exemplary may further provide that the direct current received from the DC power supply has a variable voltage that was adjusted to a value corresponding to a dimension of the work piece to be welded in the electrical resistance welding assembly. This exemplary embodiment or another exemplary may further include receiving, continuously, the direct current at the first positive terminal regardless of voltage fluctuations due to changes in resistance during welding of the work piece in the electrical resistance welding assembly. This exemplary embodiment or another exemplary may further include charging, continuously, the at least one device as the switch transitions repeatedly between an on-state and an off-state. This exemplary embodiment or another exemplary may further include discharging direct current from the at least one device in response to the switch having transitioned from the off-state to the on-state. This exemplary embodiment or another exemplary may further provide that charging the at least one device and discharging direct current from the at least one device occur simultaneously. This exemplary embodiment or another exemplary may further provide that the energy storage assembly is free of any transformer.

In yet another aspect, an exemplary embodiment of the present disclosure may provide a method comprising: confirming that a switch is in operative electrical communication with a direct current (DC) power supply, an energy storage assembly, and an electrical resistance welding assembly that is adapted to weld a work piece; receiving direct current from the energy storage assembly at a first terminal on the switch; transitioning the switch from an off state to an on state; transferring direct current from a second terminal on the switch to the electrical resistance welding assembly in response the switch having transitioned to the on state, wherein the electrical resistance welding assembly is adapted to weld the work piece in response to receiving direct current from the switch. This exemplary embodiment or another exemplary may further provide that transitioning the switch from the off state to the on state is accomplished by a semiconductor. This exemplary embodiment or another exemplary may further provide that the semiconductor is a transistor. This exemplary embodiment or another exemplary may further include transferring direct current through a first bank of a first plurality of semiconductors on the switch; and transferring direct current through a second bank of a second plurality of semiconductors on the switch. This exemplary embodiment or another exemplary may further provide that the first bank of the first plurality of semiconductors is electrically parallel to the second bank of the of the second plurality of semiconductors. This exemplary embodiment or another exemplary may further include transferring direct current through a source busbar, wherein a source connection on each of the semiconductors in the first bank and the second bank are electrically connected to the source busbar. This exemplary embodiment or another exemplary may further include transferring direct current through a drain busbar, wherein the drain busbar has at least two portions, wherein direct current is transferred from a drain connection on each of the semiconductors in the first bank to a first portion of the drain busbar and direct current is transferred from a drain connection on each of the semiconductors in the second bank to a second portion of the drain busbar. This exemplary embodiment or another exemplary may further include transferring direct current from the first portion of the drain busbar and the second portion of the drain busbar to a central portion of the drain busbar, wherein the second terminal is connected to the central portion of the drain busbar. This exemplary embodiment or another exemplary may further provide that the first plurality of semiconductors of the first bank are electrically parallel to each other. This exemplary embodiment or another exemplary may further include transferring, simultaneously, a gate voltage to each gate connection of the first plurality of semiconductors and the second plurality of semiconductors, wherein the gate voltage is controlled by a programmable logic controller (PLC). This exemplary embodiment or another exemplary may further provide that the number of semiconductors in the first plurality of semiconductors is in a range from two to ten. This exemplary embodiment or another exemplary may further provide that the number of semiconductors in the first plurality of semiconductors is either six or eight. This exemplary embodiment or another exemplary may further include transitioning the switch from the off state to the on state in less than about 0.3 milliseconds. This exemplary embodiment or another exemplary may further include controlling variable voltage from the DC power supply and the energy storage assembly with the switch.

In yet another aspect, an exemplary embodiment of the present disclosure may provide a method comprising: confirming that an electrical resistance welding assembly is in operative electrical communication with a direct current (DC) power supply, an energy storage assembly, and a switch; receiving direct current from the switch at a positive terminal on the electrical resistance welding assembly; welding a work piece in the electrical resistance welding assembly; and transferring direct current from a negative terminal on the electrical resistance welding assembly to a first negative terminal on the energy storage assembly and then from a second negative terminal on the energy storage assembly to a negative terminal on the DC power supply. This exemplary embodiment or another exemplary may further include moving an electrode on the electrical resistance welding assembly after receiving direct current from the switch having transitioned from an off state to an on state that causes current to be discharged from the energy storage assembly that is free of any transformer. This exemplary embodiment or another exemplary may further include contacting the electrode with the work piece; and transferring current through the electrode into the work piece, wherein the current is received through the switch from a supercapacitor in the energy storage assembly. This exemplary embodiment or another exemplary may further include initiating a subsequent weld at the electrical resistance welding assembly after a voltage of the supercapacitor in the energy storage assembly has recovered from a previous weld. This exemplary embodiment or another exemplary may further provide that a period of time between the previous weld and the subsequent weld is less than about 1.5 seconds. This exemplary embodiment or another exemplary may further include receiving a signal at the electrical resistance welding assembly indicative of the supercapacitor in the energy storage assembly has recovered from a previous weld and that a subsequent weld can be initiated. This exemplary embodiment or another exemplary may further provide that the signal is dependent on a recovery time of the supercapacitor in the energy storage assembly. This exemplary embodiment or another exemplary may further include delaying the subsequent weld if a programmable logic control (PLC) has that voltage in the supercapacitor has not recovered within the recovery time. This exemplary embodiment or another exemplary may further provide that the signal is sent after a programmable logic control (PLC) has analyzed a voltage recovery rate of the supercapacitor in the energy storage assembly after the electrical resistance welding assembly welds the work piece.

### BRIEF DESCRIPTION OF THE DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 (FIG. 1) is a diagrammatic perspective view of a welding system according to one exemplary embodiment of the present disclosure.

FIG. 2 (FIG. 2) is an enlarged diagrammatic perspective view of an energy storage assembly and a switch in the welding system.

FIG. 3A (FIG. 3A) is a top plan view of the energy storage assembly.

FIG. 3B (FIG. 3B) is an end elevation view of the energy storage assembly depicting three supercapacitors aligned in series.

FIG. 3C (FIG. 3C) is a side elevation view of the energy storage assembly depicting four parallel rows of the supercapacitors.

FIG. 4A (FIG. 4A) is a top perspective view of the switch.

FIG. 4B (FIG. 4B) is a bottom perspective view of the switch.

FIG. 5A (FIG. 5A) is a top plan view of the switch.

FIG. 5B (FIG. 5B) is a side elevation view of the switch.

FIG. 5C (FIG. 5C) is an end elevation view of the switch.

FIG. 5D (FIG. 5D) is an elevational cross-section view taken along line 5D-5D in FIG. 5A.

FIG. 6 (FIG. 6) is a perspective view of an exemplary transistor that is utilized in the switch.

FIG. 7A (FIG. 7A) is a top plan view of the exemplary transistor.

FIG. 7B (FIG. 7B) is an end elevation view of the exemplary transistor.

FIG. 7C (FIG. 7C) is a side elevation view of the exemplary transistor.

FIG. 8 (FIG. 8) is schematic view of the electrical circuitry of the welding system.

Similar numbers refer to similar parts throughout the drawings.

### DETAILED DESCRIPTION

The figures depict a welding system at 10. Welding system 10 may include a power supply 12, an energy storage assembly 14, a switch assembly 16 (which may simply be referred to as switch 16), and an electrical resistance welding assembly 18.

The components of welding system 10 can be described relative to each other based on their operative location within the welding system 10. Thus, terms like “upstream” and “downstream” can be used as descriptors that identify one component's relative operative location to another component's operative location. For example, within welding system 10, the power supply 12 is operatively located upstream from the energy storage assembly 14, the switch 16, and the electrical resistance welding assembly 18 inasmuch as the power supply 12 supplies electrical current to those components that are operatively downstream from the power supply 12. The energy storage assembly 14 is operatively located downstream from the power supply 12 as it receives electrical current from the power supply 12, and the energy storage assembly 14 is operatively located upstream from the switch and the electrical resistance welding assembly 18 as current is transferred from the energy storage assembly 14 to the switch 16 and then to the electrical resistance welding assembly 18. The switch 16 is operatively located downstream from the energy storage device 14 as it receives electrical current from the energy storage device 14, and the switch 16 is operatively located upstream from the electrical resistance welding assembly 18 as current is transferred from the switch 16 to the electrical resistance welding assembly 18. The electrical resistance welding assembly 18 is located operatively downstream from the switch 16 inasmuch as it receives current from the switch 16 in order to perform an electrical resistance weld on a metal component that is to be joined or welded together.

The components of welding system 10 may be joined in electrical communication via electrical cables 20. Cable 20A may connect a positive terminal 26 on power supply 12 with a corresponding positive terminal 28 on energy storage device 14. Cable 20B may connect a positive terminal 34 on energy storage device 14 with a positive terminal 36 on the switch 16. Cable 20C may connect a positive terminal 38 on the switch 16 with a positive terminal 40 on the electrical resistance welding assembly 18. Cable 20D may connect a negative terminal 30 on energy storage device 14 with a negative terminal 32 on the electrical resistance welding assembly 18. Cable 20E may connect a negative terminal 22 on power supply 12 with a corresponding negative terminal 24 on energy storage device 14. Together, cables 20A, 20B, 20C, 20D, and 20E effectuate an electrical circuitry loop that current flows upstream-to-downstream from the positive terminal 26 on the power supply 12 through the arranged components to the negative terminal 22 on power supply 12.

In one exemplary embodiment, power supply 12 is a DC power supply capable of providing a wide range of voltage (0-12V) and high current (0-650 A). This exemplary power supply 12 is used to deliver the necessary electrical energy to create the resistance heating required for welding. The power supply 12 may offer a variable voltage output within the range of 0 to 12 volts, however other voltage ranges are possible such as from 0 volts up to 24 volts, 36 volts, or 48 volts. This adjustable voltage range is advantageous because different welding applications may require varying levels of voltage depending on the materials being welded and the desired weld quality. Lower voltage settings are often used for thinner materials, while higher voltage settings are employed for thicker materials or to achieve deeper weld penetration.

The power supply 12 can also provide a high current output ranging from 0 to 650 amperes. The ability to supply such high current is advantageous for the resistive welding processes, as the welding current generates the heat necessary to melt and join the work piece 72 materials in the welding assembly 18. The adjustable current range allows for precise control over the welding process, accommodating different material thicknesses and welding requirements.

To maintain the welding quality and ensure safety, the power supply 12 should offer precise control over both voltage and current. Welding parameters, such as voltage and current, can be set and monitored to achieve the desired weld quality and consistency. Additionally, the power supply 12 may feature safety mechanisms, such as overcurrent protection and short-circuit protection, to prevent damage to the equipment and ensure operator safety.

In one exemplary embodiment, power supply 12 can provide a constant current mode. In this mode, the power supply 12 maintains a steady current output even if the voltage fluctuates due to changes in the resistance of the welding process. This ensures that the welding process remains stable and consistent.

Given the high current capacity, the power supply 12 can be capable of delivering substantial power output. In the case of the specified range (0-12V, 0-650 A), the maximum power output would be about 12V×650 A=7,800 watts (or 7.8 KW). This high power output is required to generate the intense heat needed for effective welding.

Power supply 12 may also optionally include efficient cooling systems to dissipate the heat generated during high-current operation. There may also be safety features like thermal protection to prevent overheating. Further, power supply 12 may be equipped with digital controls and displays, allowing for precise parameter adjustment and monitoring. These controls may include programmable settings for different welding scenarios.

The energy storage assembly 14 can be any assembly capable of storing energy. In some embodiments, the energy storage assembly 14 comprises at least one supercapacitor 42. In one particular embodiment, the energy storage assembly 14 comprises a plurality of supercapacitors 42. Supercapacitors 42, also known as ultracapacitors or electrochemical capacitors, are energy storage devices that store electrical energy through a double-layer capacitance and faradaic pseudocapacitance. Supercapacitors 42 are advantageous because they can discharge and charge almost as fast as desired by the user. Additionally, the supercapacitors 42 do not have a memory such that they can be discharged to their full cycle.

Supercapacitors 42 may have two electrodes, typically made of activated carbon or other conductive materials. These electrodes provide a high surface area for the accumulation of charges. One electrode is positively charged, while the other is negatively charged. The electrodes of the supercapacitors 42 are typically made from highly porous materials with an exceptionally high surface area. Common materials used for supercapacitor electrodes include activated carbon, graphene, carbon nanotubes, and conductive polymers. The choice of material affects the performance characteristics of the supercapacitor, including its capacitance, power density, and energy density. The porous structure of the electrode materials is beneficial because it provides a large surface area for the accumulation of electrical charge. The greater the surface area, the more ions and electrons the electrodes can store. This porous structure is often achieved through techniques like chemical activation or carbonization of precursor materials. The electrode materials should have high electrical conductivity to facilitate the flow of electrons during charge and discharge cycles. In one particular example, carbon-based materials are used based on their exceptional electrical conductivity, however other materials could be utilized. In some cases, metal oxides may be used to enhance the capacitance of the electrodes, but they may have lower conductivity. The electrodes can take various shapes, such as foils, films, or three-dimensional structures. Foil and film electrodes are common in traditional designs, while three-dimensional structures, such as activated carbon-based materials with interconnected pores, can increase the effective surface area and, consequently, the capacitance. In the supercapacitors 42, the electrodes may be connected to current collectors, typically made of conductive metals like aluminum or copper or others. These current collectors can serve as the electrical connection points for the supercapacitor 42, allowing for the transfer of charge to and from the external circuit.

According to one example, the porous electrodes of the supercapacitors 42 may be immersed in an electrolyte, which can be an ionic liquid, an aqueous solution, or a gel. The electrolyte contains ions that can be rapidly adsorbed and desorbed by the electrode materials during the charging and discharging processes. During the charging process, ions from the electrolyte are adsorbed onto the electrode surfaces, accumulating electrical charge. When the supercapacitor 42 is discharged, these stored ions are released, allowing the discharge of electrical energy.

The supercapacitor 42 may have a separator. One exemplary separator is a porous separator made of a material like cellulose or nonwoven fabric separates the two electrodes to prevent a short circuit. The separator allows for the flow of ions while keeping the electrodes physically apart. The separator in the supercapacitor 42 physically separates the two electrodes (positive and negative) while allowing for the flow of ions and preventing electrical short circuits. The separators in the supercapacitors 42 are typically made of porous insulating materials that do not conduct electricity. Some exemplary separator materials include: natural cellulose-based materials, such as paper or wood fibers, are often used as separator materials; polymeric materials; ceramic materials. Synthetic polymer separators, including materials like polyethylene, polypropylene, or other specialty polymers, may be utilized. These polymers are chosen for their mechanical strength and chemical stability. Alternatively, some supercapacitors, especially those designed for high-temperature or harsh environments, may use ceramic separators due to their excellent thermal stability and chemical resistance.

The separator of the supercapacitor 42 can be a highly porous structure. This porosity creates a network of interconnected pores, which is advantageous for ion transport. It provides a large surface area for electrolyte infiltration and allows ions to move freely while preventing electrons from passing through. The interconnected pores ensure efficient ion diffusion and low resistance. The thickness of the separator in the supercapacitor 42 can vary depending on the specific design and application of the supercapacitor. A thinner separator can reduce the internal resistance of the supercapacitor, allowing for faster charge and discharge, but it may also affect the mechanical robustness. Thicker separators provide better mechanical support but might increase resistance.

The separator of the supercapacitor 42 should be highly wettable, which means it should readily absorb and distribute the electrolyte within its porous structure. Proper wettability ensures that the separator and electrodes are effectively soaked in the electrolyte, enabling efficient ion transport and preventing dry spots that can lead to performance degradation. Additionally, the separator should be resistant to the temperature and chemical conditions encountered during the operation of the supercapacitor. This is particularly advantageous in high-temperature and corrosive environments. The separator of the supercapacitor 42 should be compatible with the chosen electrolyte to prevent chemical reactions that could degrade the separator or the electrodes. The electrolyte, which is an ionic conducting solution or gel, fills the space between the electrodes and the separator. It facilitates the transport of ions between the two electrodes, enabling the charging and discharging of the supercapacitor 42.

The choice of electrolyte can significantly impact the performance characteristics of the supercapacitor, including its capacitance, voltage range, and temperature stability. Several types of electrolytes are commonly used aqueous electrolytes, organic Electrolytes, ionic liquids, or polymer electrolytes. Aqueous electrolytes are water-based and often use dissolved salts (such as sodium or potassium salts) to create an ionic medium. Aqueous electrolytes are known for their high conductivity, low cost, and relatively safe operation. They are possible in supercapacitors 42 that could be designed for lower voltage applications. Organic electrolytes are typically non-aqueous and use organic solvents like acetonitrile or propylene carbonate. They are used in supercapacitors that require a wider voltage range and higher energy density. Organic electrolytes can support higher operating voltages but safety concerns, such as flammability, should be accounted for. Ionic liquids are a class of non-aqueous, non-volatile electrolytes. They have unique properties, such as wide electrochemical windows and non-flammability. Ionic liquids are often used in supercapacitors for specific applications where safety and stability are critical. Polymer electrolytes are solid or gel-like electrolytes that use polymer matrices with dissolved salts. Polymer electrolytes are useful for their safety and flexibility.

Regardless of electrolyte type, the electrolyte should have high ionic conductivity to allow for the rapid movement of ions within the supercapacitor 42 during charge and discharge cycles. Higher conductivity enables faster charging and discharging, leading to higher power density. Additionally, the electrolyte should be electrochemically stable within the voltage range of the supercapacitor 42. For example, in aqueous electrolytes, the voltage range is limited to avoid water electrolysis. In non-aqueous electrolytes, compatibility with the chosen electrode materials is critical to prevent unwanted chemical reactions. The viscosity of the electrolyte can affect the rate of ion transport. Lower viscosity electrolytes allow ions to move more freely, contributing to faster charge and discharge rates. The electrolyte should maintain its ionic conductivity and stability over a range of operating temperatures. This is more important in applications where the supercapacitor 42 may be exposed to extreme temperature conditions, for example, if system 10 was to be utilized in an unheated factory or fabrication facility.

The supercapacitor 42 additionally includes a current collector. Current collectors, often made of conductive metals like aluminum or copper, are connected to the electrodes. These current collectors allow for the electrical connection of the supercapacitor 42 to an external circuit, such as to the power supply 12 or the switch 16 in the example of system 10. The current collector in the supercapacitor 42 serves as the bridge between the electrodes and the external circuit and is responsible for providing an electrical pathway between the electrodes and the external circuit. It assists in conducting the flow of electrons to and from the electrodes during the charge and discharge processes.

Current collectors in the supercapacitor 42 are typically made of highly conductive materials to minimize electrical resistance. Some exemplary materials used for current collectors in the supercapacitor include aluminum, copper or other materials. Aluminum foils can be used as current collectors due to their excellent electrical conductivity, mechanical strength, and corrosion resistance. Aluminum foils can be employed in supercapacitors 42 designed for lower cost and high-performance applications. Copper foils are another common choice, known for their even higher electrical conductivity compared to aluminum. Copper is often used in high-performance supercapacitors where low resistance is crucial, such as those designed for advanced energy storage systems. In some specialized applications, other conductive metals like stainless steel or nickel can be used as current collectors, depending on the specific design requirements.

The current collector of the supercapacitor 42 typically takes the form of a thin, flat sheet, often in the shape of a foil or a grid, which is positioned adjacent to the electrode. The design of the current collector can impact the distribution of electrical charge and the overall performance of the supercapacitor 42. In one example, the current collector is securely attached or bonded to the electrode material, ensuring a strong and low-resistance connection. Various methods, including adhesives or thermal bonding, may be used to attach the current collector to the electrode. The size and shape of the current collector can vary depending on the specific design of the supercapacitor 42. The current collector should cover the entire surface of the electrode to ensure effective electron flow. In some designs, it may also extend beyond the edges of the electrode to provide a connection point for the external circuit. The interface between the current collector and the electrode should have minimal contact resistance to allow efficient electron transfer. The construction should ensure good contact inasmuch as poor contact can lead to energy loss and reduced performance. The current collector material should be compatible with the chosen electrolyte to avoid unwanted chemical reactions that could degrade the collector. Additionally, the current collector should resist corrosion and degradation, especially when exposed to the electrolyte.

The supercapacitor 42 is encased in a durable housing or container, which can be made of materials like aluminum, plastic or stainless steel. The housing helps protect the internal components and maintains the integrity of the supercapacitor. However, the supercapacitor 42 housing may be made of materials that are durable, electrically insulating, and resistant to environmental factors. In one particular embodiment, aluminum is a suitable choice for supercapacitor housings due to its lightweight, corrosion resistance, and high strength. It can be used in both cylindrical and prismatic supercapacitors. Yet, some supercapacitors, particularly those in smaller, prismatic form factors, may have housings made of plastic materials. Plastic housings are lightweight and can be cost-effective. Stainless steel can be used in high-performance or specialized supercapacitors. It provides excellent corrosion resistance and mechanical strength. The shape and design of the housing can vary depending on the form factor of the supercapacitor. Common shapes of the housing include cylindrical, prismatic, and coin cell, among others. The design must accommodate the internal components, such as the electrodes, separator, and electrolyte, while providing structural integrity. The housing must be sealed tightly to prevent the ingress of moisture, dust, or contaminants, which could degrade the internal components and affect the performance of the supercapacitor 42. Proper sealing is advantageous for maintaining the integrity of the device. The housing serves as an electrical insulator, preventing unintended electrical contact between the supercapacitor's internal components and the external environment. This insulation ensures safe operation.

Supercapacitors 42 have terminal connections that extend through the housing to allow for electrical connections to the external circuit. The terminals can be designed in various forms, such as leads, pins, or wire connections, depending on the supercapacitor's intended use. In some exemplary supercapacitor designs, pressure relief mechanisms or venting may be included to release internal pressure if it builds up during operation.

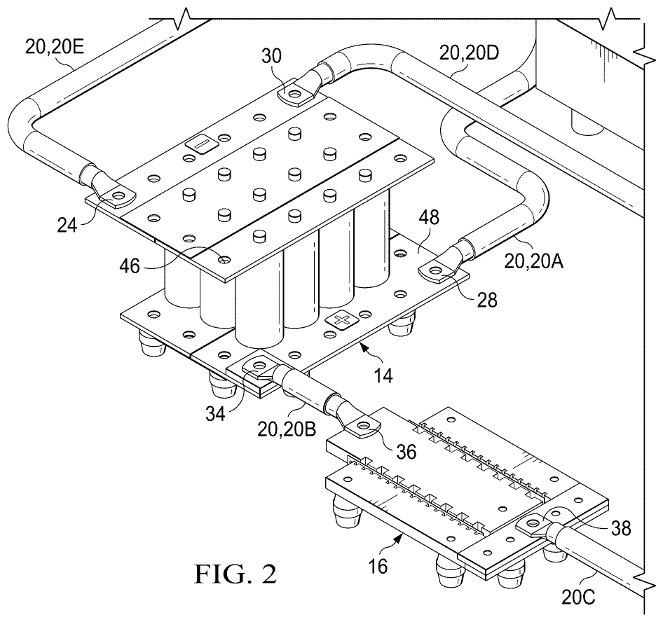

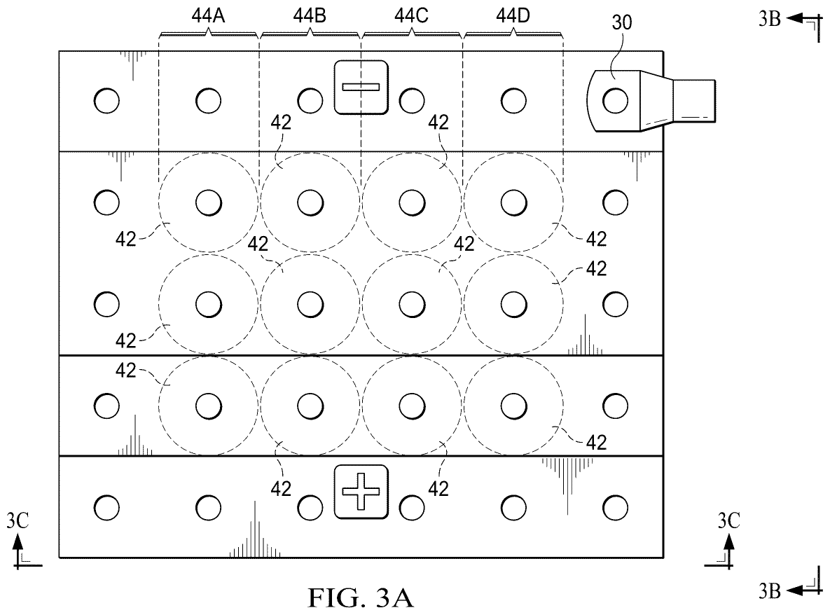

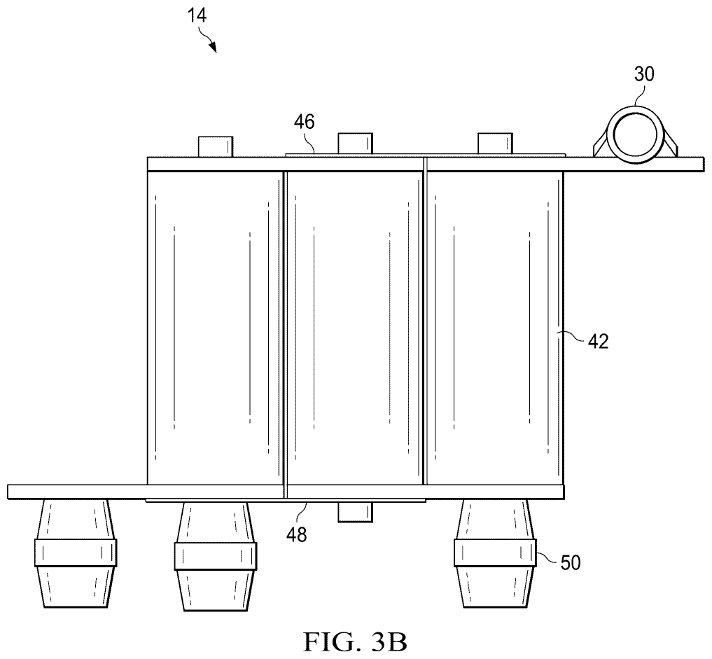

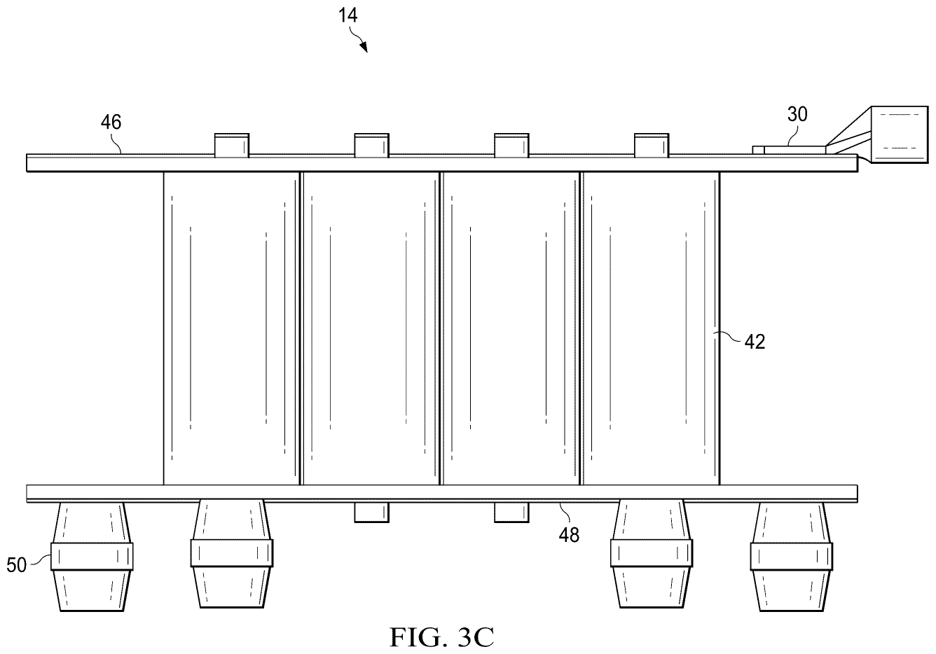

FIG. 2 and FIG. 3A-3C depicts one particular arrangement of the energy storage assembly 14 in system 10. In this embodiment, the energy storage assembly 14 comprises a plurality of supercapacitors 42. This exemplary arrangement has a bank or array of twelve supercapacitors 42. In this particular example, the twelve supercapacitors 42 are arranged with a series of three supercapacitors aligned in four electrically parallel rows or groups 44A, 44B, 44C, and 44D.

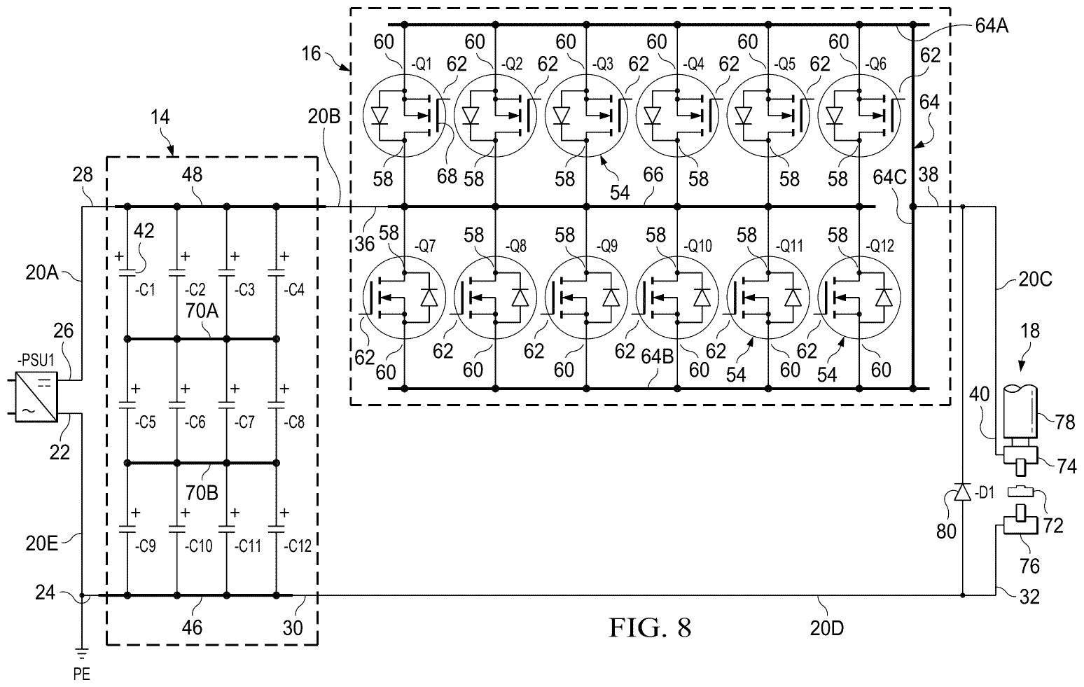

To arrange a bank or array of twelve supercapacitors 42 with a series of three supercapacitors 42 aligned in four electrically parallel rows 44A-44D, there is a configuration that combines both series and parallel connections. This arrangement may assist in achieving a desired voltage and capacitance for specific applications. Within each row, three supercapacitors 42 are connected in series. This means that the positive terminal of one supercapacitor is connected to the negative terminal of the next one, and so on. This series connection sums the voltage of each supercapacitor 42. If each supercapacitor 42 in a given row has an exemplary voltage of 3V, then each respective row 44A-44D of supercapacitors connected in series would provide a total voltage of 9V (3 supercapacitors*3V each). Then, to connect the four rows 44A-44D of supercapacitors in parallel, all the positive terminals of the first supercapacitors in each row 44A-44D together (which can be accomplished via plate 48, discussed below) and all the negative terminals together (which can be accomplished via busbar 70A; see FIG. 8). For this particular example, this parallel connection adds up the capacitance of the individual supercapacitors while maintaining the total voltage at 3V.

In keeping with this exemplary configuration and voltages, the energy storage assembly 14 would achieve a maximum voltage of 9V (as the rows 44A-44D are connected in series, and each row 44A-44D is parallel to the others which contributes 9V). In this exemplary embodiment, the capacitance adds up in parallel, which would result in a total capacitance of 12×3000 F=36,000 Farads (36 F). This exemplary arrangement allows the energy storage assembly 14 to have a relatively high capacitance (e.g., about 36,000 F) while still maintaining a 9V voltage.

With continued reference to FIG. 2 and FIG. 3A-3C, the bank or array of supercapacitors 42 may be positioned between a negative plate 46 and a positive plate 48. The negative plate 46 may couple the terminal 24 and terminal 30 with the negative terminal of supercapacitors 42. The positive plate 48 may couple the terminal 28 and terminal 34 with the positive terminal of supercapacitors 42. Positive plate 48 may also be connected with a plurality of footings 50 or footers that helps support the energy storage assembly 14 when it is installed in system 10. In one embodiment, footers 50 are insulated stand offs to elevate the positive plate 48 (or another plate to which footers are attached, such as those footers 50 used on switch 16) above the ground level or another platform. The footers 50 may insulate portions of the energy storage assembly 14 or otherwise have general insulating properties.

Depending on the maximum voltage needed for the system, and the maximum voltage of the supercapacitor(s) used, would determine how many supercapacitors are required in series. Similarly depending on the maximum power storage needed (Farads) and depending on the Farads specified for each capacitor would determine the total number of capacitors, arranged in parallel that would be needed.

Although the arrangement of twelve supercapacitors 42 was described with reference to one example, it would be possible to alter the number of supercapacitors depending on the application specific needs and functionality of system 10. For example, if the system 10 needs to achieve a similar total capacitance but with a different number of supercapacitors 42, a system designer could adjust the configuration to meet those specific requirements. For example, to maintain a total capacitance of 36,000 Farads (36 F) while using a different number of supercapacitors 42, a system designer can change the number of supercapacitors 42 in each series or parallel group. In this example, the system designer could change the number of super capacitors in series. If it is desired to use fewer supercapacitors 42 but maintain the same maximum voltage (e.g., 9V), the number of supercapacitors in each series group can be reduced. For example, if two supercapacitors in series are used, then six rows of these 2-series supercapacitors would be needed. This configuration would provide a total capacitance of 6×3000 F=18,000 Farads (18 F).

Conversely, if a system designer wants to use more supercapacitors 42 and still maintain the same maximum voltage (e.g., 9V), the number of supercapacitors in each parallel group can be increased. For instance, if four supercapacitors in parallel are used, then three rows of these 4-parallel supercapacitors are needed. This configuration would provide you with a total capacitance of 3×4×3000 F=36,000 Farads (36 F).

Still further, another example can utilize a combination of both approaches. For example, a system designer might choose to use two supercapacitors in series and two of these series groups in parallel. In this case, six rows of these 2-series, 2-parallel supercapacitors would be needed. This configuration would maintain the same voltage of 9V and provide a total capacitance of 6×(2×3000 F)=36,000 Farads (36 F).

To achieve the desired voltage, the system designer will arrange the correct number of capacitors in series, adding the voltages of each capacitor. The more current needed in the system to perform a weld would result in the arranging the correct number of capacitors in parallel. When adding capacitors in parallel, the capacitance and thus the current in the system increase but not the voltage. Therefore through the arrangement of capacitors in series and in parallel a system with the needed voltage and current can be created. Thus, the number of supercapacitors 42 in series and parallel can be adjusted to achieve the desired total capacitance while keeping the voltage consistent. Thus, the energy storage assembly 14 provides the flexibility in how to configure the supercapacitors 42 to suit the specific requirements of a particular welding application.

One particular embodiment determined that the twelve supercapacitors 42, shown in FIG. 3A and FIG. 8, was sufficient for welding 8 mm wires within the electrical resistance welding assembly 18. This arrangement of supercapacitors 42 would also enable sheet metal welding with the sheet metal having a thickness between 1 mm and 3 mm. Further, welding for these thicknesses typically occurs around the 10 volt range. As discussed herein, the voltage that system 10 welds is determined by the number of supercapacitors 42 that are in series with each other. Then there can be as many supercapacitors 42 as necessary electrically parallel to each other to obtain more or less welding current. In the shown exemplary embodiment there are at least three supercapacitors 42 in series with each other, however there may be fewer if less voltage is required. For example, if the system 10 must weld at about 9 volts and each super capacitor is 3 volts, then the series arrangement of three supercapacitors 42 of 3 volts each result in a total voltage of 9 volts. If the system needed to weld at 12 volts, then four supercapacitors 42 can be aligned in series. If the system need to weld at 15 volts, then five supercapacitors 42 could be arranged in series. Alternatively, if each super capacitor has a different voltage rating, then a different number of super capacitors can be utilized to achieve said total voltage output. For example, if 5 volt super capacitors are utilized and a total voltage of 15 volts is needed, then only three of the 5 volt super capacitors could be provided in series to achieve the total system voltage of 15 volts. Notably, however the maximum voltage applies or corresponds to the maximum diameter or thickness of the work pieces 72 (see FIG. 8) that are being welded. Take for example, an 8 mm diameter wire (e.g., an exemplary work piece 72) that is to be welded, it typically requires about 8000 amps to achieve an acceptable weld, while smaller wires would require less current. In a given welding system one might need to increase or decrease the voltage to achieve the desired current. It is the resistance in the system that determines how much voltage is needed to drive the desired current. Thus, the energy storage device 14 composed of the plurality of supercapacitors 42 works in conjunction with the variable voltage DC power supply 12 to selectively determine or selectively vary the DC power to be supplied from supply 12 based on user selected inputs that correspond to the thickness of the work pieces or wires that are to be welded via assembly 18.

The energy storage assembly 14 comprising the super capacitors 42 can be charged to any voltage desired by the user. Thus, while the 9 volts in this particular embodiment is exemplary, the charge may be any value between 0 volts and 9 volts, 12 volts, or 15 volts, or any other maximum voltage that depends on the thickness of the work piece 72. This is advantageous because it allows the user to select the voltage for which the weld is to be completed. This is in contradistinction to the former techniques of using transformers that have a voltage determined by the turns ratio or number of turns in the wires forming the transformer. Thus, in previous welding techniques using transformers, there was no selectivity available by using transformers having a single voltage. Thus, one aspect of the present disclosure enables a voltage to be selected in response to a size or dimension of the work piece 72 that is to be welded.

The energy storage assembly 14 has been described in the above exemplary embodiments as utilizing supercapacitors 42 that have unique energy storage devices with certain advantages, such as high power density and rapid charge/discharge capabilities. However, depending on specific application and requirements, a system 10 designer could consider alternative energy storage devices, components or solutions that can achieve similar functionality in a similar way to achieve a similar result. For example, instead of supercapacitors 42, it may be possible for the energy storage assembly 14 to utilize batteries, such as Lithium-ion and other advanced battery technologies, which can provide high energy density and a wide range of voltage and capacity options. Batteries can store more energy than supercapacitors but typically have slower charge/discharge rates. Alternatively, ultrabatteries could be utilized in the energy storage assembly 14. Ultrabatteries are hybrid energy storage devices that combine the characteristics of both batteries and supercapacitors. They offer a compromise between the high energy density of batteries and the high power density of supercapacitors. Still further, in certain applications, hydrogen fuel cells can provide a combination of high power and energy density. They are especially suitable for situations where extended power generation is needed. Furthermore, electrochemical capacitors could be utilized. These are similar to supercapacitors 42 but may use different materials or designs to optimize specific parameters like energy density or power density. Still further, any of the above could be combined in a hybrid energy storage system, wherein combining multiple energy storage technologies, such as batteries and supercapacitors, in a single system can provide a balance between energy storage capacity and power delivery.

The switch 16 is in electrical communication with the energy storage assembly 14. In one particular embodiment, the switch is a MOSFET weld switch for the welding process. This approach eliminates the need for a traditional transformer-based power supply, offering several advantages in terms of flexibility and efficiency.

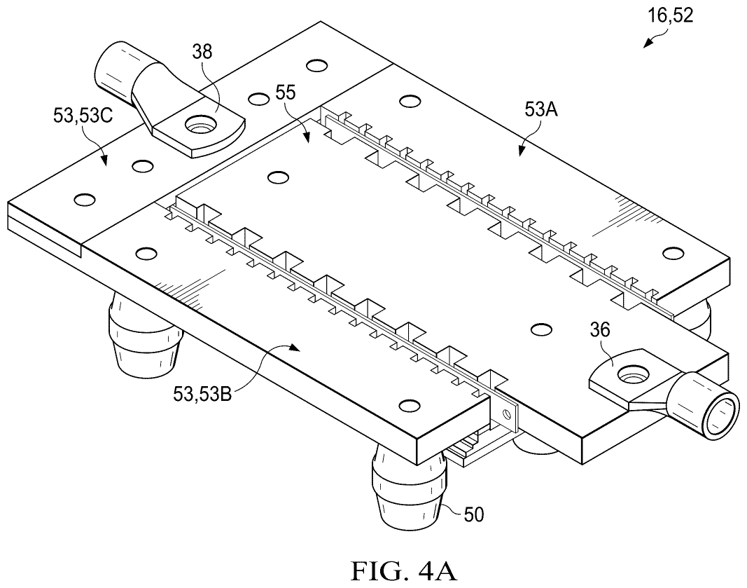

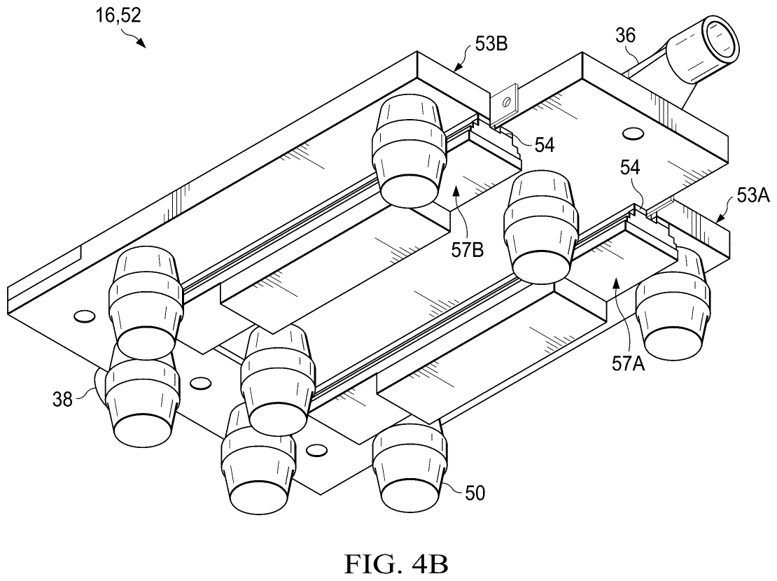

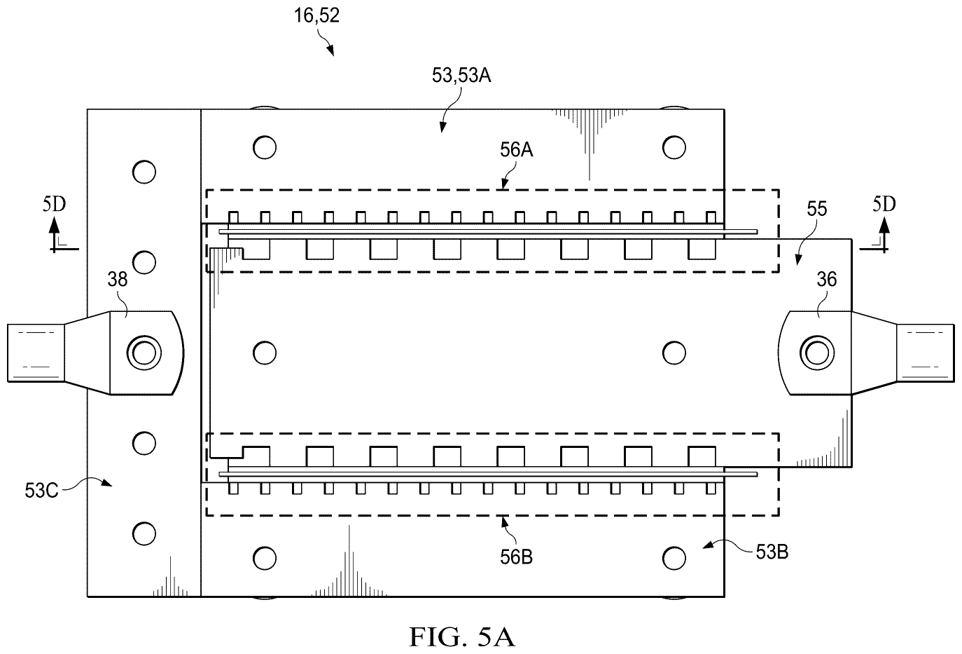

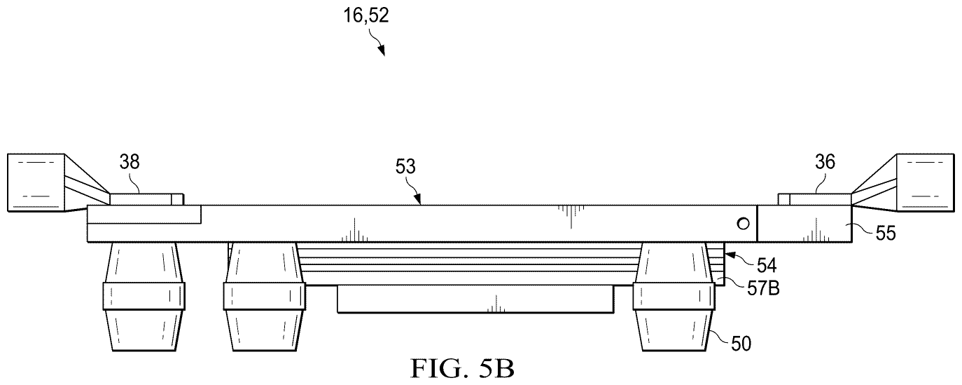

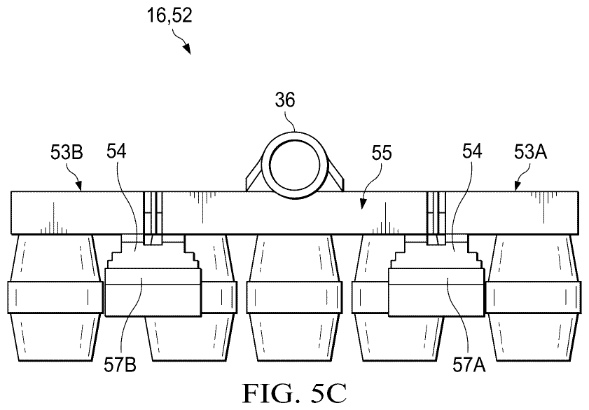

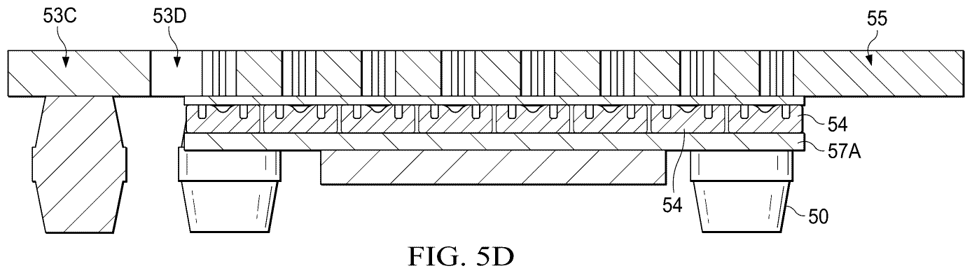

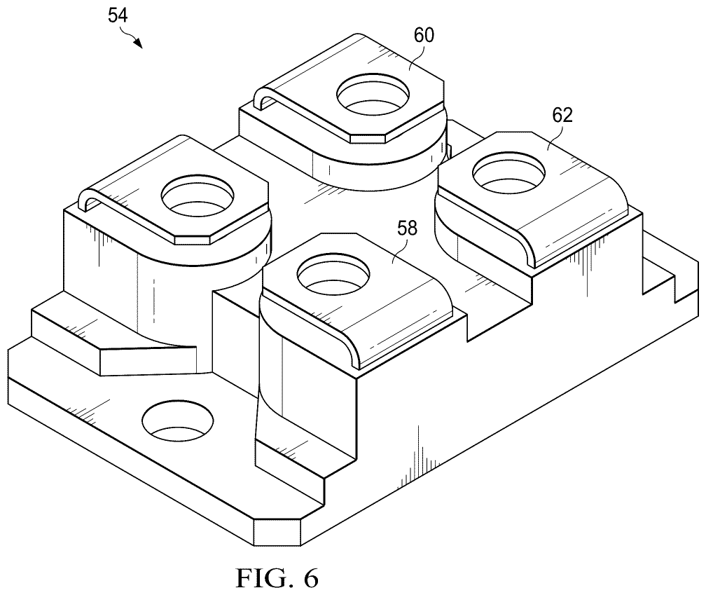

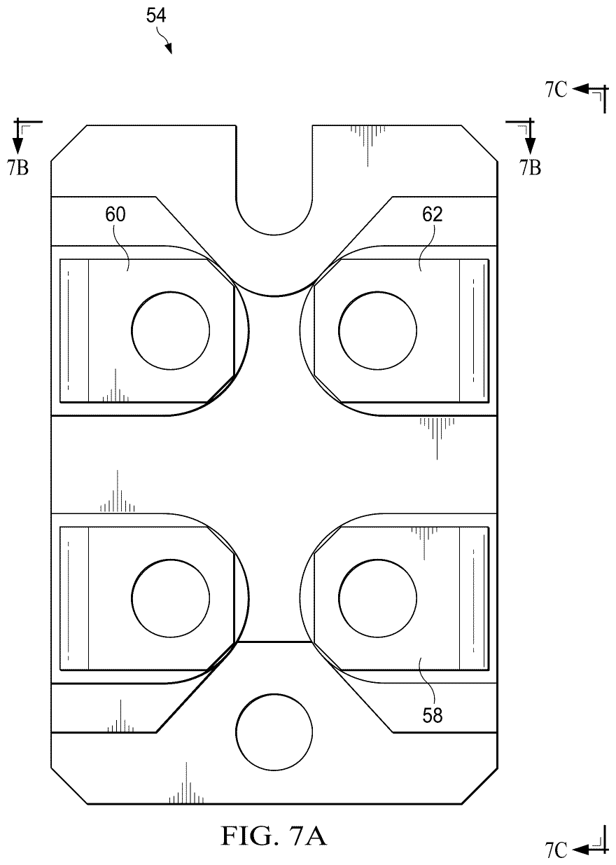

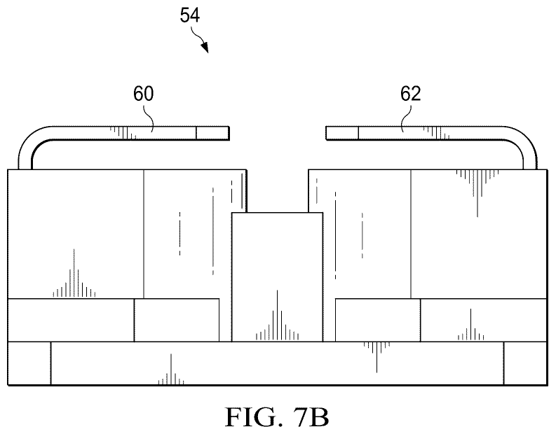

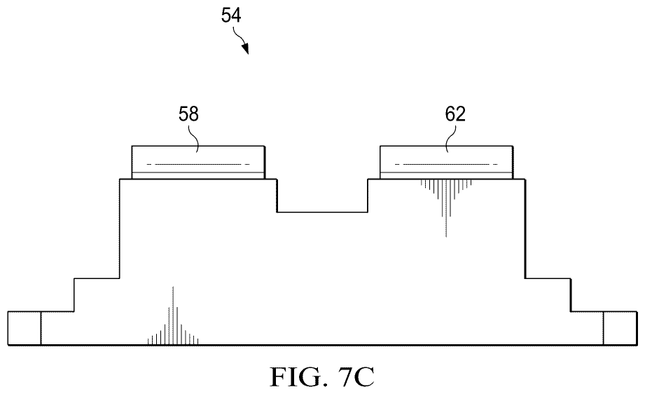

FIG. 4A-4B, FIGS. 5A-5D, FIG. 6, FIGS. 7A-7C, and FIG. 8 depict an exemplary switch 16 that is embodied as a MOSFET weld switch assembly 52. The exemplary MOSFET weld switch assembly 52 in this welding system 10 is a robust and efficient solution for controlling the welding current. The assembly 52 includes a U-shaped plate 53 having a top surface and a bottom surface. The U-shaped plate includes a first leg 53A, a second leg 53B, and a central leg 53C connecting the first leg 53A to the second leg 53B. The terminal 38 is connected with central leg 53C. A central plate 55 is located within the space between the first leg 53A and the second leg 53B of the U-shaped plate 53. The terminal 36 is connected to the central plate 55. A slight gap is defined between the perimeter edge of the central plate 55 and the inner edges of the first leg 53A and the second leg 53B of the U-shaped plate 53. A first support plate 57A spans the gap below the first leg 53A and the central plate 55. A second support plate 57B spans the gap below the second leg 53B and the central plate. The first support plate 57A and the second support plate 57B support transistors, namely Metal-Oxide-Semiconductor Field-Effect Transistors (MOSFETs) 54. The MOSFETs 54 also span the gap between the U-shaped plate 53 and the central plate 55.

The parallel arrangement of N-channel MOSFETs 54, with a central source busbar and two drain busbars, minimizes resistance, handles high currents, and ensures rapid and precise switching. This exemplary design offers the flexibility required for variable voltage welding and allows for precise control over the welding process, ultimately enhancing the adaptability and quality of the welds produced by the multi-spot resistive welding assembly 18.

The MOSFET switch assembly 52 is designed with up to sixteen parallel N-channel MOSFETs 54. These MOSFETs 54 are organized into two banks (e.g. first bank 56A and second bank 56B) of up to eight MOSFETs 54, with one central source busbar and a drain busbar that may be composed of two or more drain busbars components, segments or portions. The first bank 56A span the gap between the first leg 53A of the U-shaped plate 53 and the central plate 55. The second bank 56B span the gap between the second leg 53B of the U-shaped plate 53 and the central plate 55. The selected MOSFET for this exemplary design is the IXTN600N04T2, known for its capacity to handle a continuous current of 600 amperes and low resistance, boasting just about 1.3 milliohms. With sixteen MOSFETs in parallel, the total resistance of the switch assembly drops to about 0.08 milliohms. However, other MOSFET can be utilized.

The selected MOSFETs 54 for this exemplary application are N-channel MOSFETs. N-channel MOSFETs are a common type of MOSFET used in high-power applications because they offer several advantages, including low on-resistance (RDS (on)) and good performance characteristics when used as switches. In this example, the MOSFETs 54 are organized in a parallel configuration, with up to 16 N-channel MOSFETs working together (e.g. eight MOSFETs in each bank 56A, 56B that are electrically parallel to each other). This parallel configuration offers several advantages. With respect to current handling, this arrangement allows the system 10 to handle high welding currents effectively. Each MOSFET 54 shares a portion of the total current, distributing the load evenly and preventing overheating or excessive current stress on individual MOSFETs 54. There is a low total resistance as the combined resistance of the parallel MOSFETs 54 is significantly lower than that of a single MOSFET 54.

In this particular embodiment, in the parallel configuration, the N-channel MOSFETs 54 are connected to a central source busbar 66. The source connection 58 is where the current flows into the MOSFETs. All of the source terminals or source connections 58 of the MOSFETs 54 are electrically connected to this central busbar 66. In one embodiment, the central plate 55 may act as the central busbar 66. Then, this example may provide two drain busbars that are employed in this configuration, serving as the output drain connections 60 for the MOSFETs 54. In one embodiment, the U-shaped plate 53 may act as the drain busbar wherein the first leg 53A is one of the two drain busbars components (e.g. first drain busbar 64A—see FIG. 8) and the second leg 53B is the other of the two drain busbars components (e.g., second drain busbar 64B—see FIG. 8). The drain connections 60 are where the current exits the MOSFETs. These two drain busbars 64A, 64B are usually arranged on opposite sides of the central source busbar 66, providing redundancy and improving current distribution.

The gate connection 62 of each N-channel MOSFET 54 is responsible for controlling the switching operation. To switch a MOSFET on or off, a voltage is applied to its gate connection 62 or gate terminal. In the context of welding, this gate voltage is controlled by a Programmable Logic Controller (PLC) or a similar control system, allowing precise and rapid switching during the welding process.

One of the advantages of the selected IXTN600N04T2 N-channel MOSFETs 54 is their low on-resistance (RDS (on)). A low RDS (on) value means that these MOSFETs 54 have minimal resistance when in the on-state. This characteristic is desirable in high-current applications because it minimizes power dissipation and heat generation. The exemplary N-channel MOSFETs 54 chosen for this configuration should have a fast switching time, requiring less than about 0.3 milliseconds to transition between the on state and off state (or from the off state to the on state, repeatedly). This swift/quick switching capability ensures precise control over the welding process, enabling the system 10 to respond rapidly to changing requirements. The pulse width modulation (PWM) controlled switching of the MOSFET can achieve a sloped or increasing weld current (slope) at the beginning of a weld. This control can be used to achieve slope settings at the beginning of a weld or to manage the transition between on and off states with precision.

The switching speed of the MOSFETs 54 in the welding system 10 is a parameter that determines how quickly the MOSFETs 54 can transition between the on state and off state. Switching speed, often referred to as the “switching time,” is the time it takes for a MOSFET to change from the off state (non-conductive) to the on state (conductive), and vice versa. It is typically measured in fractions of a second, such as milliseconds (ms) or microseconds (μs). In the context of welding, the switching speed is a factor that impacts the precision and efficiency of the welding process.

In welding applications, achieving rapid and precise switching is advantageous for several reasons. Since the switching speed determines how quickly the welding current can be turned on and off, this level of control is beneficial in managing the electrical energy delivered to the weld spot. Fast switching allows for precise and consistent control of the heat generated during the welding process. Rapid and consistent switching ensures that the welding conditions remain stable from one weld to the next. Inconsistent switching times can lead to variations in the quality of the welds and can affect the final product's integrity. Different welding scenarios may require different welding parameters. The ability to switch rapidly enables the system to adapt to various material thicknesses, types of joints, and welding techniques.

The MOSFETs 54 also have a response time. A rapid response time offers several advantages in the welding process. The quick response time ensures that the welding current can be precisely controlled. This is especially important in resistance welding, where the heat generated at the weld spot must be precisely managed to create a strong and consistent bond. The ability to rapidly turn off the welding current helps minimize the heat-affected zone (HAZ) around the weld spot. A smaller HAZ results in less thermal distortion and reduced risk of damaging the surrounding material. In a multi-spot welding system, each welding spot should receive the same treatment for uniform quality. Fast switching and fast response ensures that all welding spots receive consistent energy input, which is crucial for producing high-quality welds across multiple spots.

The switching speed is coordinated by the PLC that uses digital outputs to send signals to the MOSFET gate terminals or gate connections 62, ensuring that the switching is timed accurately and synchronized with the welding process.

Although the aforementioned example of switch assembly 16 has been made with reference to a MOSFET, other types of semiconductors could be utilized as well. For example, instead of a MOSFET it is possible to construct switch assembly 16 with IGBTs, GTOs or SCRs (Thyristors).

Operationally, variable voltage control is achieved through PWM switching, however the supercapacitors 42 enable adjustment of the welding voltage by changing the charge voltage of the supercapacitors. The variable voltage control for the welding process of the present disclosure, unlike traditional transformers with fixed voltage settings determined by turns ratios, the energy storage assembly 14 can be charged to any voltage. In one embodiment, the voltage may be any voltage between 0 and 9 volts. In another embodiment, the voltage may be any voltage between 0 and 12 volts. This flexibility allows welders or operators to choose the ideal voltage for the specific plate thickness or wire diameter, making it an ideal solution for adapting to various welding scenarios or different work pieces 72. Variable voltage control, in the context of the multi-spot resistive welding system 10 with a bank of supercapacitors 42, is a feature that allows welders or operators to adjust and select the voltage applied to the welding process. Unlike traditional welding systems with fixed voltages determined by transformer turns ratios, system 10 offers precise control over the welding voltage.

In one particular embodiment of system 10, the supercapacitors 42 serves as the primary source of electrical energy. The voltage across the supercapacitor bank can be adjusted and set to any level within a specified range, typically between 0 and 9 volts or between 0 and 12 volts. This wide range of voltage settings offers several advantages. Namely, different welding scenarios often involve varying materials, thicknesses, and welding requirements. By adjusting the supercapacitor voltage, welders or operators can fine-tune the welding process to match the specific characteristics of the material being welded. For instance, lower voltage settings are appropriate for welding thin materials, preventing excessive heat and burn-through. And, higher voltage settings are used for thicker materials to ensure adequate penetration and a strong weld.

Additionally, the ability to vary the welding voltage according to the specific application eliminates the need for multiple welding setups with fixed transformer voltages. This adaptability of system 10 simplifies the welding process and reduces the need for complex settings adjustments. Welders or operators can choose the ideal voltage that best suits the welding scenario, making it an efficient and versatile solution.

Further, unlike traditional welding systems with fixed voltage settings, in system 10 the use of a supercapacitors 42 within the energy storage assembly 14 with variable voltage control negates the need for setting heat percentages. Heat percentage settings are used to control the energy delivered to the weld spot, and they can be complex to adjust and fine-tune. In the supercapacitor-based system 10 of the present disclosure, this setting is no longer necessary because the voltage directly controls the heat input. By using variable voltage, the supercapacitor-based system 10 of the present disclosure manages the heat input based on the selected voltage, simplifying the welding setup and operation. Thus, one of the notable simplifications in this system 10 is the elimination of the heat percentage setting commonly found in traditional transformer-based systems. The absence of heat percentage settings, fixed transformer voltage settings, and multiple parameter adjustments significantly reduces the complexity of setting up the welding process. Additionally, welders or operators can precisely control and adjust the voltage to match their specific requirements. The result is a high degree of control over the welding process in system 10, ensuring that the weld quality is consistent and optimal for the given materials and welding conditions. Welders or operators no longer need to calculate or fine-tune the heat input, which can be particularly advantageous in high-production environments where simplicity and efficiency are key. Further, system 10 provides simplified welding settings that enhance the user experience, making the system 10 more accessible to welders of varying skill levels. It reduces the learning curve and minimizes the risk of setup errors, resulting in improved productivity and consistent weld quality.

The variable voltage control provided by system 10 should also optimize the welding process, resulting in high-quality welds and reduced rework. It minimizes the risk of overheating or under-heating the work piece 72, leading to a stronger and more reliable weld. This adaptability enhances the overall efficiency of the welding system 10. Thus, the primary weld settings in this system 10 are simple and straightforward. In one particular embodiment, welders or operators only need to set the capacitor charge voltage, thereby eliminating the need for complex adjustments associated with traditional transformer-based systems.

While traditional slope settings may not be necessary due to the variable voltage capability, if the system desires to achieve a slope or gradually increasing voltage and thus current at the beginning of a weld, a PWM (pulse width modulated) switching of the switch 16 is employed. This level of control further enhances the adaptability and precision of the welding process. Slope settings, often referred to as ramp-up or ramp-down settings, are used to control the rate at which the welding current or voltage increases or decreases at the start or end of a weld. Gradually increasing the current or voltage at the beginning of a weld helps prevent “cold starts,” where the welding process begins with insufficient energy input, resulting in a weak initial bond. If desired, slope settings can help minimize spatter by allowing the welding process to stabilize gradually. This may be important in applications where spatter can be detrimental. Slope settings also help reduce thermal distortion in the work piece 72 by providing a controlled and gradual heat input. This is important for maintaining the integrity of the welded material, particularly in applications involving thin or heat-sensitive materials. If desired, slope settings can be adjusted to suit specific welding scenarios and material types. For example, thicker materials might require a longer and gentler slope, while thinner materials may benefit from a shorter and steeper slope. The adaptability of slope settings allows welders to optimize the welding process for different applications. By controlling the rate of change in welding parameters, slope settings contribute to consistency and quality in the welds. They help ensure that each weld starts smoothly and stabilizes before the main welding phase, reducing the risk of defects and ensuring the integrity of the welded joints.

System 10 should also simplify the setup process. In one particular embodiment, welders/operators only need to set the supercapacitors 42 charge voltage and a welding time, thereby eliminating the need for cumbersome and less precise heat percentage settings that are common with traditional transformer-based systems. In this system 10, one exemplary welding parameter to set is the capacitor charge voltage. This voltage level is adjustable and is a factor in determining the voltage applied during the welding process. Operationally, welders can set the capacitor charge voltage within a specific range, typically between 0 and 9 volts or between 0 and 12 volts. This range is wide enough to accommodate various welding scenarios and material thicknesses. Welders can select the appropriate charge voltage based on the thickness and type of material being welded. Different materials and thicknesses may require different voltage settings for optimal results.

The timing and control of the gate switching for the MOSFETs 54 are managed by the PLC. Digital outputs from the PLC are used to control the MOSFET gate switching between the on state and the off state. In one exemplary embodiment, RS485 communications are employed to convey the required capacitor voltage to the power supply 12. The PLC may also receive an analog input to monitor the actual capacitor voltage, allowing it to determine when the next weld can be initiated. This timing ensures that welding can resume once the capacitor voltage has sufficiently recovered after the previous weld. The timing and synchronization ensures that the MOSFET switches open and close at the right moments during the welding process. The precise timing of current switching is advantageous for controlling heat input, maintaining consistency, and achieving high-quality welds. The PLC allows welders to configure various control parameters that influence the welding process. The PLC enables the desired voltage to be set for the supercapacitors 42 using the PLC interface. This voltage selection directly determines the current applied during the weld. The PLC allows the duration of the welding process to be specified. This parameter influences the overall energy input and heat generated during the weld. If desired (although not required), the PLC can be used to control the initial slope of voltage or current at the beginning of a weld, allowing for customization based on specific welding scenarios. The PLC may also continuously monitor the welding process by interfacing with various sensors and feedback mechanisms. It receives information about the actual voltage and current levels during the weld, allowing it to make real-time adjustments if needed. The PLC can incorporate safety checks and interlocks to ensure the system operates safely. For example, it can verify that the supercapacitor voltage is within a safe range before allowing a weld to start. If safety limits are breached, the PLC can prevent the welding process from proceeding. The PLC may also communicate with other systems and components in the welding setup. This can include communication with the supercapacitor bank to set the desired charge voltage and monitor voltage levels. It may also communicate with an HMI (Human-Machine Interface) for operator interaction and display of critical information. Further, after each weld, the PLC manages the recovery of the supercapacitors to the desired charge voltage, ensuring that the system is ready for the next weld. The PLC can also control the sequencing of multiple welding spots in a multi-spot welding system, ensuring that each spot receives the necessary energy input. Still further, the PLC provides a platform for adaptability and customization. Welders and operators can program the PLC to match specific welding scenarios and material requirements, making it a versatile and user-friendly tool. The PLC can also log data related to each weld, including voltage, current, and timing information. This data can be used for quality assurance, process analysis, and documentation. The PLC can be a distinct component within the system 10. Alternatively, the PLC may be integrated into the DC power supply 12 or the welding assembly 18. In one particular embodiment, the PLC is a back off PLC.

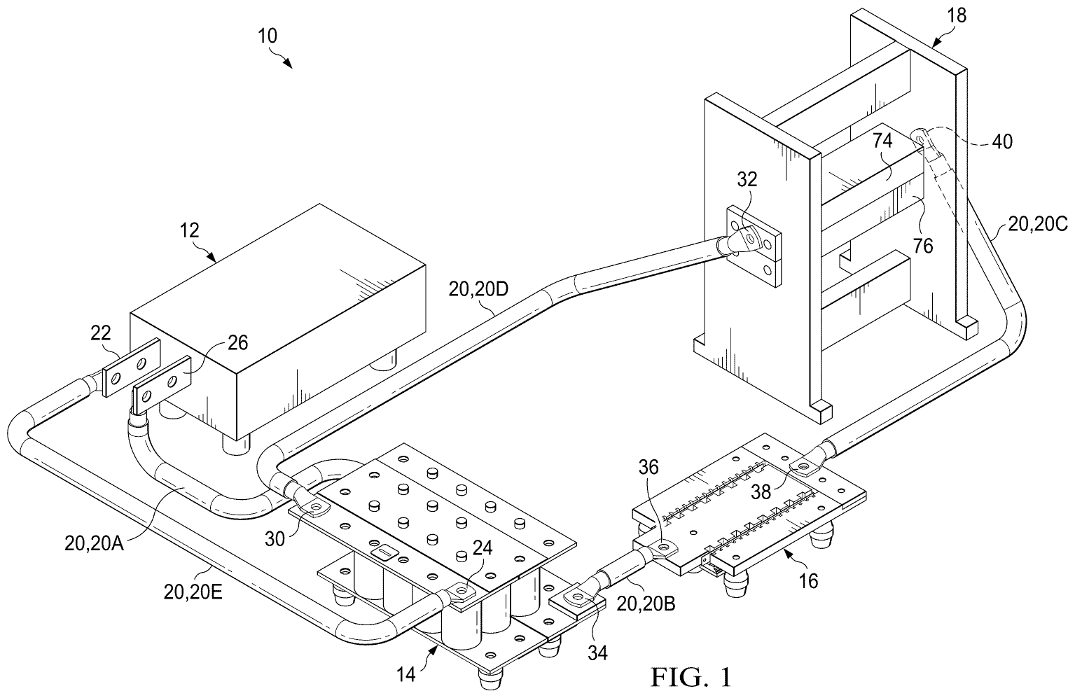

With reference to FIG. 1 and FIG. 8, the electrical resistance welding assembly 18, according to one exemplary embodiment, may be a multi-spot resistive welding assembly with two welding heads used to join metal components together. Assembly 18 may have two welding heads, and distribution busbars for welding current. The welding heads are the components responsible for applying pressure and current to the work pieces 72 to be welded. In a multi-spot welding assembly 18, there are two welding heads, each with its own set of electrodes. One welding head may be equipped with a set of top electrodes 74. These top electrodes come into contact with the top surface of the work pieces 72 to create electrical and thermal connections. Similarly, one welding head may also have a set of bottom electrodes 76, which make contact with the bottom surface of the work pieces 72. This completes the electrical circuit and enables the welding process. The two welding heads are usually positioned on opposite sides of the work piece 72. This allows for a balanced application of pressure and current to create multiple weld spots simultaneously. The top electrodes 74 from each welding head may be aligned with each other and positioned over the top surface of the work pieces 72. The bottom electrodes 76 from each welding head may be likewise aligned with each other and placed beneath the work pieces 72.

One exemplary assembly 18 may also have two distribution busbars, one for supplying the top electrodes 74 and another for supplying the bottom electrodes 76. These distribution busbars act as electrical conductors that distribute the welding current to the electrodes 74, 76. They are responsible for delivering the necessary electrical energy to create the resistance heating required for welding. In one exemplary configuration there may be two separate distribution busbars, wherein one busbar connects to the top electrodes 74 of both welding heads, while the other connects to the bottom electrodes 76. These busbars are typically made of highly conductive materials to minimize electrical resistance.

Assembly 18 may also include or otherwise be in operative communication with a control system, often the PLC or another computerized control unit, that manages the welding process. As mentioned previously, the PLC controls the timing, pressure, and welding current for each welding head to ensure consistent and reliable welds. The PLC is one exemplary control system used in industrial automation, such as multi-spot resistive welding assembly 18. The PLC should be capable of precise control, real-time operation, and interfacing with sensors, actuators, and HMI (Human-Machine Interface) devices. Some exemplary non-limiting PLCs include: Siemens S7-1500, Allen-Bradley ControlLogix, Omron CJ2M Series, Mitsubishi MELSEC-Q Series, or Beckhoff TwinCAT. The choice of PLC depends on specific requirements, including the number of welding spots, the complexity of the welding process.

Programming the PLC for controlling the multi-spot resistive welding assembly 18 involves creating a control program that manages the welding process, monitors sensors, controls the welding heads, and interfaces with an HMI for operator interaction. The PLC should be configured by defining the I/O points for the welding heads, sensors (e.g., temperature, pressure, current), and actuators (e.g., pneumatic cylinders for applying pressure). This configuration is usually accomplished using the PLC's software tool, such as Siemens TIA Portal, Rockwell Studio 5000, or the appropriate software for the chosen PLC. The developer should develop a control program that includes logic for sequencing the welding process, monitoring sensor inputs to ensure that the welding conditions meet quality standards, controlling the welding current to the top and bottom electrodes, managing the timing and synchronization of the welding process for multiple spots, and handling fault detection and error recovery, amongst other possibilities. Once the program is validated, the system should be commissioned in the actual manufacturing environment, any necessary adjustments should be made for optimal performance. PLCs may require ongoing maintenance and may need occasional updates to the control program as the welding system evolves or to address issues.

The HMI interface should be created for the operator to set welding parameters, monitor the welding process, and view alarms or diagnostic information. PLCs often have built-in HMI options or can communicate with external HMI devices. communication between the PLC and other systems, such as quality control systems, data logging systems, or remote monitoring should be established. This can be done using various communication protocols (e.g., Ethernet/IP, Modbus, OPC).

The PLC's ability to determine when the next weld can be initiated is an advantageous aspect of ensuring the safety and efficiency of the welding process. It involves monitoring the recovery of the supercapacitor bank's voltage after a previous weld and deciding when the system is ready for the next weld.

The welding process occurs via assembly 18. Then, the welding process for the previous weld is completed as determined by the pre-set welding time or other relevant parameters. In one embodiment, the PLC continuously monitors the voltage across the energy storage assembly 14, such as supercapacitor bank, using inputs that may be either digital or analog. However, it is also possible for the PLC to periodically monitor the voltage. When monitored continuously, this monitoring provides real-time data on the voltage level, and the PLC can observe how quickly it is recovering. The PLC is pre-programmed with a voltage recovery threshold that indicates when the voltage of the energy storage assembly 14, such as the supercapacitor bank's voltage, has sufficiently recovered for the next weld that is to be performed by assembly 18. This threshold value is based on the specific requirements of the welding process and the recovery times (e.g., 0.5 seconds for a mesh welder and about 1.5 seconds for a jig welder).

When the previous weld is completed by assembly 18, the PLC starts to analyze the voltage recovery rate. It calculates how quickly the voltage is rising and compares it to the predetermined recovery threshold. If the PLC determines that the supercapacitor bank's voltage has exceeded or reached the recovery threshold within the specified time frame (e.g., 0.5 seconds for a mesh welder or 1.5 seconds for a jig welder), it signals that the system is ready for the next or subsequent weld. If the voltage recovery is too slow or has not reached the threshold within the specified time frame, the PLC will delay the initiation of the next weld and continue monitoring the voltage recovery.

The PLC typically communicates the readiness status to the operator through a Human-Machine Interface (HMI) or a display. This can include indicating a “ready” status or displaying a countdown timer to the next weld. When the PLC determines that the supercapacitor bank's voltage has fully recovered, it initiates the next weld by sending the necessary signals to the MOSFET-based switch assembly 52 and other relevant components. This includes setting the capacitor charge voltage based on the welding requirements. Throughout the welding process, the PLC continues to monitor the voltage and other critical parameters to ensure that the welding conditions remain stable and safe. The PLC may also incorporate safety features, such as the ability to trigger alarms or stop the process if the voltage recovery is not proceeding as expected or if any anomalies are detected during the next weld.

The embodiments of welding system 10 implement electrical resistance welding via assembly 18 without the need for a transformer. One exemplary advantage of system 10 is that it provides the same DC welding quality as MFDC welding systems but with greater efficiency, lower power consumption, reduced weight (e.g., lowering the mass of moveable components to thereby increase efficiency), and decreased cost. It also provides the ability to control or eliminate the secondary voltage for more precise control over the weld, which is in contrast to traditional welding transformers that have a fixed secondary voltage. In conventional DC electrical resistance welding, the term “secondary voltage” refers to the voltage output from the welding transformer, wherein the transformer is absent from system 10.

Having thus described some exemplary embodiments and the parameters of the components, reference will now be made with respect to the control of the welding operation in system 10.

In operation and with reference to FIG. 1 and FIG. 8, regarding the welding system 10, current flows from the positive terminal 26 on the DC power supply 12. The current flows through cable 20A to the terminal 28 at the positive plate 48 of the energy storage assembly 14. From the terminal 28, the current flows into the supercapacitors 42. As the DC power supply 12 is turned on or initiated, the current charges the supercapacitors 42. Once the supercapacitors 42 are charged (or at least partially charged), the current is then fed to terminal 34 on the positive plate 48 to be transferred along cable 20B to the terminal 36 located on the switch 16. The supercapacitors 42 will discharge in response to the switch 16 being actuated from its off state to its on state. As the weld is occurring in the welding assembly 18, the voltage in the supercapacitor 42 will drop slightly. In response to this slight drop of the voltage in the supercapacitor 42, there is an automatic flow of current from the voltage supply 12 into the energy storage device 14 to recharge the supercapacitors 42.

In one particular embodiment, there is a continuous flow of DC current into the energy storage assembly 14 from the DC power supply 12. However, simultaneous to this continuous flow of DC current, is a discharge of DC current in short bursts for each weld occurring at the electrical resistance welding assembly 18. The rate of discharge or burst of time at which voltage is discharge from the energy storage assembly 14 is typically on the order of about 100 milliseconds. After said discharge of DC current, the assembly 18 may wait for a moment, such as another second or some other time period, and then perform a subsequent weld for the work pieces 72 at the same location or a different location for another 100 milliseconds or so. During the dwell time between the two welding periods, the DC power supply 12 is continuously supplying and recharging the super capacitors 42 to the energy storage assembly 14.

With respect to the switch 16 defined by assembly 52, there is a drain busbar 64 that is composed of a first portion 64A and a second portion 64B that are linked together via a central connector 64C (the first portion 64A may correspond to first leg 53A, the second portion may correspond to second leg 53B, and the central connector may correspond to central leg 53C). There is also a source busbar 66 (which may correspond to plate 55). The MOSFET transistors 54 are located between the source bus bar 66 and the drain bus bar 64. In the shown embodiment there are twelve MOSFETs 54. However, it is to be understood that the number of transistors can be scaled up or scaled down depending on the application specific needs of switch 16. For example, FIG. 8 depicts that there are two series or banks of six parallel MOSFET transistors 54, however it is to be understood that there could be two series of eight parallel MOSFET transistors 54, or ten parallel MOSFET transistors, or twelve parallel MOSFET transistors 54 or any other value that a system designer would deem necessary to complete the operation of welding system 10. For example, if a higher current application is needed, then there may be twelve or more parallel MOSFET transistors 54 in each bank or series 56A, 56B. However, if a lower current application is needed then there may be less than six parallel MOSFET transistors 54 within the two series or banks. In operation, a voltage may be applied to the gate of each of the MOSFETs 54 to transition the transistor from an off state to an on state (i.e., to open the switch). When the correct voltage is applied to the gate 62 of each of the MOSFET 54, they collectively cooperate and function together as a collective switch that now enables the switch 16 to transition from its off-state to its on-state. In one embodiment, each transistor can switch about 400 amps continuously.

With continued reference to FIG. 8, within the energy storage assembly 14, there are at least two copper busbars that effectuate the parallel arrangement of the supercapacitors 42 that are arranged in series. Namely, first bus bar 70A and second bus bar 70B which are located between the plate 48 that functions as the positive capacitor busbar and the plate 46 that function as the negative capacitor busbar, respectively.

In the shown embodiment of FIG. 8, there are multiple series of three supercapacitors aligned in four electrically parallel rows or groups 44A, 44B, 44C, and 44D. The first group 44A is composed of the supercapacitors 42 labeled C1, C5, and C9 that are electrically connected in series. The second group 44B is composed of the supercapacitors 42 labeled C2, C6, and C10 that are electrically connected in series. The third group 44C is composed of the supercapacitors 42 labeled C3, C7, and C11 that are electrically connected in series. The fourth group 44D is composed of the supercapacitors 42 labeled C4, C8, and C12. To connect the four groups 44A-44D in parallel, the first busbar 70A electrically connects the negative terminal of supercapacitors C1, C2, C3, and C4 with the positive terminal of supercapacitors C5, C6, C7, and C8, and the second busbar 70B electrically connects the negative terminal of supercapacitors C5, C6, C7, and C8 with the positive terminal of supercapacitors C9, C10, C11, and C12.

Current will flow from the positive terminal 34 on the energy storage assembly 14 through cable 20B to the terminal 36 on the switch 16. The terminal 36 on the switch 16 is linked with the source busbar 66. If there is no current on the gate of the MOSFET 54, then MOSFETs 54 will stay closed (i.e., the off state) and current will not be permitted to flow therethrough. If the proper gate voltage is applied to transition the MOSFETs 54 from their off-state to their on-state, then current can flow along the source busbar 66 and though each of the MOSFETs 54 to the drain busbar 64. Typically, the gate voltage to transition each MOSFET 54 is in a range from about 2 volts to about 24 volts, however other gate voltages are possible. In one embodiment, the gate voltage that is applied to each of the gates of each MOSFET 54 is applied at the same time. The PLC is in operative communication with the switch 16 to control the gate voltage to appropriately time the application of the gate voltage to switch the MOSFET transistors 54 from their off-state to their on-state to permit the flow of current through the switch 16.

Some of the current flows through the MOSFET transistors 54 towards the first portion 64A of drain busbar 64 and some portion of the current will flow towards the second portion 64B of the drain busbar 64. Given that the first and second portion 64A, 64B are linked via the central portion 64C of drain busbar 64 the current distribution will be balanced between the two series or banks 56A, 56B of the parallel MOSFET transistors 54.

The current will leave the switch 16 via terminal 38 and travel towards the weld assembly 18 via cable 20C. The weld piece or work piece 72 is positioned between the top electrode 74 and the bottom electrode 76 of the weld assembly 18. The weld press 78 applies a force and presses the top electrode 74 downwardly onto the work pieces 72. Current moves through the top electrode 74, through the work pieces 72 and into the bottom electrode 76. From the bottom electrode 76 the current flow outwardly along cable 20D back to the terminal 30 on plate 46 of the energy storage assembly 14.

As shown in FIG. 8, the system 10 may include a freewheeling diode 80 that is a one-way diode that prevents current flowing from terminal 38 to pass through diode 80. However, the direction of electrical travel through diode 80 may occur as current leaves the bottom electrode 76. The reason the diode 80 is present within the system 10 is that when the MOSFET transistors 54 are switched off, they are incredibly fast and the current stops almost instantaneously. Even though the inductance in the welding circuit is very low, the rapid change of current induces an induced voltage. Even though the inductance is very low, the rate of change of current is so high with the MOSFET 54 that a small number multiplied a large number is a significant number. This results in a voltage spike when the MOSFET transistors 54 are stopped suddenly. That voltage spike may exceed 100 volts. This can severely damage or destroy the switch 16. Thus, when welding ceases the diode 80 permits the current to keep flowing in a freewheeling circuit for a few milliseconds to allow the current to slowly dissipate over a period of time, usually in a range from about 5 milliseconds to 10 milliseconds to negate the massive change in current from 8,000 amps to 0 amps in about a nanosecond.

One or more of the individual assemblies or system 10 of the present disclosure may additionally include one or more sensors to sense or gather data pertaining to the voltage, temperature displacement, surrounding environment or operation of the device, assembly, or system. Some exemplary sensors capable of being electronically coupled with the device, assembly, or system of the present disclosure (either directly connected to the device, assembly, or system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, local pressure changes, presences liquid; impellers measuring the amount of fluid passing thereby; Global Positioning sensors sensing location, elevation, distance traveled, velocity/speed; audio sensors sensing local environmental sound levels, or voice detection; Photo/Light sensors sensing ambient light intensity, ambient, Day/night, UV exposure; TV/IR sensors sensing light wavelength; Temperature sensors sensing machine or motor temperature, ambient air temperature, and environmental temperature; and Moisture Sensors sensing surrounding moisture levels.

If sensors are utilized to gather data relating to the device, assembly, or system of the present disclosure, then sensed data may be evaluated and processed with artificial intelligence (AI). Analyzing data gathered from sensors using artificial intelligence involves the process of extracting meaningful insights and patterns from raw sensor data to produce refined and actionable results. Raw data is gathered from various sensors, for example those which have been identified herein or others, capturing relevant information based on the intended analysis. This data is then preprocessed to clean, organize, and structure it for effective analysis. Features that represent key characteristics or attributes of the data are extracted. These features serve as inputs for AI algorithms, encapsulating relevant information essential for the analysis. A suitable AI model, such as machine learning or deep learning (regardless of whether it is supervised or unsupervised), is chosen based on the nature of the data and the desired analysis outcome. The model is then trained using labeled or unlabeled data to learn the underlying patterns and relationships. The model is fine-tuned and optimized to enhance its performance and accuracy. This process involves adjusting parameters, architectures, and algorithms to achieve better results. The trained model is used to make predictions or inferences on new, unseen data. The model processes the extracted features and generates refined output based on the patterns it has learned during training. The results produced by the AI model are refined through post-processing techniques to ensure accuracy and relevance. These refined results are then interpreted to extract meaningful insights and derive actionable conclusions. Feedback from the refined results is used to improve the AI model iteratively. The process involves incorporating new data, adjusting the model, and enhancing the analysis based on real-world feedback and evolving requirements. Further, AI results can be used to alter the operation of the device, assembly, or system of the present disclosure based on feedback. For example, AI feedback can be used to improve the efficiency of the device, assembly, or system of the present disclosure by responding to predicted changes in the environment or predicted changes to the device, assembly, or system of the present disclosure more quickly than if only sensed by one or more of the sensors.

The device, assembly, or system of the present disclosure may include wireless communication logic coupled to sensors on the device, assembly, or system. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

In another example, a point-to-point communication protocol like MiWi or ZigBee® is used. One or more of the device, assembly, or system of the present disclosure may serve as a repeater, or the devices, assemblies, or systems of the present disclosure may be connected together in a mesh network to relay signals from one device, assembly, or system to the next. However, the individual device, assembly, or system in this scheme typically would not have IP addresses of their own. Instead, one or more of the devices, assemblies, or system of the present disclosure communicates with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system that receives and processes signals from the device, assembly, or system of the present disclosure may differ from embodiment to embodiment. In one embodiment, alerts and signals from the device, assembly, or system of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as a maintenance department or production department. Thus, if a particular device, assembly, or system of the present disclosure creates an alert because of a data point gathered by one or more sensors, that alert can be sent, in e-mail or SMS form, directly to the individual responsible for fixing it or monitoring it. Of course, e-mail and SMS are only two examples of communication methods that may be used; in other embodiments, different forms of communication may be used.

In other embodiments, alerts and other data from the sensors on the device, assembly, or system of the present disclosure may also be sent to a work tracking system that allows the individual, or the organization for which he or she works, to track the status of the various alerts that are received, to schedule particular workers to repair a particular device, assembly, or system of the present disclosure, and to track the status of those repair jobs or to monitor, track and confirm the production performance of a particular device, assembly, or system of the present disclosure. A work tracking system would typically be a server, such as a Web server, which provides an interface individuals and organizations can use, typically through the communication network. In addition to its work tracking functions, the work tracker may allow broader data logging and analysis functions. For example, operational data may be calculated from the data collected by the sensors on the device, assembly, or system of the present disclosure, and the system may be able to provide aggregate machine operational data for a device, assembly, or system of the present disclosure or group of devices, assemblies, or systems of the present disclosure.

The system also allows individuals to access the device, assembly, or system of the present disclosure for configuration and diagnostic purposes. In that case, the individual processors or microcontrollers of the device, assembly, or system of the present disclosure may be configured to act as Web servers that use a protocol like hypertext transfer protocol (HTTP) to provide an online interface that can be used to configure the device, assembly, or system. In some embodiments, the systems may be used to configure several devices, assemblies, or systems of the present disclosure at once. For example, if several devices, assemblies, or systems are of the same model and are in similar locations in the same location, it may not be necessary to configure the devices, assemblies, or systems individually. Instead, an individual may provide configuration information, including baseline operational parameters, for several devices, assemblies, or systems at once.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the switch 16 having a U-shaped plate 53, the switch and its components can be semi-circular, triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, firmware or a combination thereof. When implemented in software, the software code or instructions can be executed on any suitable processor or collection of processors, whether provided in a single computer or distributed among multiple computers or in firmware. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A method comprising:
confirming a direct current (DC) power supply is in operative electrical communication with an energy storage assembly, a switch, and an electrical resistance welding assembly that is adapted to weld a work piece;
transferring direct current from a positive terminal on the DC power supply to the energy storage assembly, wherein the direct current is transferred from the energy storage assembly through the switch to the electrical resistance welding assembly; and
receiving direct current at a negative terminal on the DC power supply from the electrical resistance welding assembly in response to the work piece being welded.

2. The method of claim 1, further comprising:
adjusting a variable voltage output from the DC power supply.

3. The method of claim 2, wherein voltage is adjustably varied between 0 volts (V) and 20 V.

4. The method of claim 2, further comprising:
determining a dimension of the work piece to be welded; and
adjusting the variable voltage of the direct current to a value corresponding to the dimension of the work piece.

5. The method of claim 2, further comprising:
setting the voltage output of from the DC power supply to a value that achieves a desired weld quality for the work piece.

6. The method of claim 1, further comprising:
maintaining a direct current output from the positive terminal on the DC power supply regardless of voltage fluctuations due to changes in resistance during welding of the work piece in the electrical resistance welding assembly which is adapted to maintain consistency of a weld generating during welding by the electrical resistance welding assembly.

7. The method of claim 1, further comprising:
causing the direct current transferred from the positive terminal on the DC power supply to charge a component of the energy storage assembly.

8. The method of claim 1, further comprising:
continuously transferring direct current from the positive terminal on the DC power supply as the switch transitions repeatedly between an on-state and an off-state.

9. The method of claim 1, further comprising:
continuously transferring direct current from the positive terminal on the DC power supply to the energy storage assembly as voltage in the energy storage assembly drops in response to the work piece being welded in the electrical resistance weld assembly.

10. The method of claim 1, further comprising:
transferring direct current from the positive terminal on the DC power supply to at least one supercapacitor in the energy storage assembly.

11. The method of claim 10, further comprising:
transferring direct current from the positive terminal on the DC power supply to a first group of a plurality of supercapacitors arranged electrically in series.

12. The method of claim 11, further comprising:
transferring direct current from the positive terminal on the DC power supply to a second group of a plurality of supercapacitors arranged electrically in series, wherein the first group is electrically parallel to the second group.

13. A method comprising:
confirming that an energy storage assembly is in operative electrical communication with a direct current (DC) power supply, a switch, and an electrical resistance welding assembly that is adapted to weld a work piece;
receiving direct current from the DC power supply at a first positive terminal on the energy storage assembly;
charging at least one device of the energy storage assembly with the direct current;
transferring direct current from a second positive terminal on the energy storage assembly to the switch, wherein the direct current is adapted to be transferred from the switch to the electrical welding assembly;
receiving direct current at a first negative terminal on the energy storage assembly from the electrical resistance welding assembly in response to the work piece being welded;
transferring direct current from a second negative terminal on the energy storage assembly to the DC power supply.

14. The method of claim 13, wherein the at least one device is at least one supercapacitor.

15. The method of claim 14, further comprising:
charging a first group of a plurality of supercapacitors of the energy storage assembly, wherein the plurality of supercapacitors in the first group are electrically in series with each other.

16. The method of claim 15, further comprising:
charging a second group of a plurality of supercapacitors of the energy storage assembly, wherein the plurality of supercapacitors in the second group are electrically in series with each other.

17. The method of claim 16, wherein the first group is electrically parallel to the first group.

18. The method of claim 15, further comprising:
setting an output voltage of the energy storage assembly, wherein the output voltage is determined by the number of supercapacitors that are in series with each other.

19. The method of claim 15, wherein there are at least three supercapacitors in the first group.

20. The method of claim 14, further comprising:
charging the at least one supercapacitor to a voltage that that is dependent on a maximum thickness of the work piece that is to be welded in the electrical resistance welding assembly.

21. The method of claim 13, further comprising:
receiving a user-selected or PLC-selected output voltage of the energy storage assembly that is dependent on a thickness of the work piece that is to be welded in the electrical resistance welding assembly.

22. The method of claim 13, wherein the direct current received from the DC power supply has a variable voltage that was adjusted to a value corresponding to a dimension of the work piece to be welded in the electrical resistance welding assembly.

23. The method of claim 13, further comprising:
receiving, continuously, the direct current at the first positive terminal regardless of voltage fluctuations due to changes in resistance during welding of the work piece in the electrical resistance welding assembly.

24. The method of claim 13, further comprising:
charging, continuously, the at least one device as the switch transitions repeatedly between an on-state and an off-state.

25. The method of claim 24, further comprising:
discharging direct current from the at least one device in response to the switch having transitioned from the off-state to the on-state.

26. The method of claim 25, wherein charging the at least one device and discharging direct current from the at least one device occur simultaneously.

27. The method of claim 13, wherein the energy storage assembly is free of any transformer.
